(19) United States
(12) Patent Application Publication
(10) Pub. No.: US 2011/0018780 A1
(43) Pub. Date: Jan. 27, 2011

(54) Antenna Array For Multiple In Multiple Out (MIMO) Communication Systems

(75) Inventors: Mohammad A. Tassoudji, San Diego, CA (US); Gregory A. Breit, San Diego, CA (US); Hemanth Sampath, San Diego, CA (US)

Correspondence Address: QUALCOMM INCORPORATED, 5775 MOREHOUSE DR., SAN DIEGO, CA, 92121, US

(73) Assignee: QUALCOMM Incoporated, San Diego, CA (US)

(21) Appl. No.: 12/506,939

(22) Filed: Jul. 21, 2009

(51) Int. Cl. H01Q 21/06; H01Q 1/38; H01Q 21/28

(52) U.S. Cl. 343/844; 343/700 MS; 343/893

(57) ABSTRACT

The present disclosure provides techniques for configuring multiple element antenna arrays for use in multiple input multiple output (MIMO) communications. The antenna arrays include a ground plane and antenna elements. The ground plane forms an electrically conductive surface having a ground potential. The antenna elements, located near the ground plane, transmit and receive a wireless communication signals over a predetermined wireless channel.

### FIELD OF THE INVENTION

The present disclosure relates generally to communication systems, and, more particularly, to an antenna array for multiple in multiple out (MIMO) communication systems.

### BACKGROUND OF THE INVENTION

A multiple-input multiple-output (MIMO) communication system employs multiple transmit antennas (N_{T}) and multiple receive antennas (N_{R}) for data transmission. A MIMO channel formed by the transmit antennas N_{T} and the receive antennas N_{R} may be decomposed into independent channels (N_{S}), with N_{S} min {N_{T}, N_{R}}. Each of the independent channels N_{S} is also referred to as a spatial sub-channel of the MIMO channel and corresponds to a dimension. The MIMO system can provide improved performance (e.g., increased transmission data throughput and communication range, without using additional bandwidth or transmit power) over that of a single-input single-output (SISO) communication system, if the additional dimensionalities created by the multiple transmit and receive antennas are utilized.

To provide wireless connectivity between a portable processing device (e.g., laptop computer) and other computers (laptops, servers, etc.), peripherals (e.g., printers, mouse, keyboard, etc.), or communication devices (modems, cellular phones, smart phones, etc.) it is necessary to equip the portable device with an antenna or multiple antennas. For example, multiple antennas may be located either external to the device or integrated (embedded) within the device (e.g., embedded in the display unit).

Although an embedded antenna design can overcome disadvantages associated with external antenna designs (e.g., less susceptible to damage), embedded antenna designs typically do not perform as well as external antennas. To improve the performance of an embedded antenna, the antenna is preferably disposed at a certain distance from any metal component of the device. Another disadvantage, associated with embedded antenna designs, is that the size of the device typically is increased to accommodate antenna placement, especially when two or more antennas are used.

The IEEE 802.11 VHT (Very High Throughput) system targets network throughputs over 1 Gbps (gigabits per second) and per link throughput targeting>500 Mbps. The requirement for such a high data rate communications typically uses Multi-user (MU) MIMO techniques where the AP can use 8 to 16 antennas to communicate with clients with 1 to 4 antennas. Higher order MIMO techniques using 8-16 antennas at the AP and clients can also be used to achieve>500 Mbps per link throughput.

In high order MIMO communication systems, the design of antenna arrays becomes an increasingly important part of the system design. It is also typically desirable to limit the form factor and size of the device. Therefore, it becomes a design challenge to fit a relatively large number of antennas into a relatively small area, without decreasing channel capacity. In addition, it is desirable for convenience of cable distribution to/from antenna array to keep the antennas in close proximity to processing logic. Because of a small area of a final product, high isolation among the array elements is typically desirable, which may decrease the spatial correlation and increase the channel capacity. When designing higher order antenna arrays, several other parameters may also be considered, such as: the leakage, return loss, isolation, correlation, Eigenvalues, radiation pattern, efficiency, directivity, mechanical design, etc.

Further limitations and disadvantages of conventional and traditional approaches will become apparent to one of skill in the art of MIMO communication systems and devices, through comparison of such systems and devices with some aspects of the present invention, as set forth in the remainder of the present disclosure with reference to the drawings.

### SUMMARY OF THE INVENTION

According to one aspect of the present invention, the present disclosure provides techniques for configuring multiple element antenna arrays for use in multiple input multiple output (MIMO) communications. The antenna arrays comprise a ground plane and antenna elements. The ground plane forms an electrically conductive surface having a ground potential. The antenna elements, located near the ground plane, transmit and receive a wireless communication signals over a predetermined wireless channel.

According to other aspects of the present invention, the present invention may employ an apparatus, a wireless communication device, and associated means.

These and other aspects of the present invention will be apparent from the accompanying drawings and from the following detailed description.

### BRIEF DESCRIPTION OF THE DRAWINGS

So that the manner in which the above recited features of the present disclosure may be understood in detail, a more particular description, briefly summarized above, may be had by reference to embodiments, some of which are illustrated in the appended drawings, in which like reference numbers designate corresponding elements. It is to be noted, however, that the appended drawings illustrate only certain typical embodiments of this disclosure and are therefore not to be considered limiting of its scope, for the description may admit to other equally effective embodiments.

FIG. 1 illustrates an example of a multiple in multiple out (MIMO) wireless local area network (WLAN) communication system, in accordance with certain aspects of the present disclosure.

FIG. 2 illustrates an example of further details of an access point and a user terminal, each employing an antenna array, as shown in the system of FIG. 1, in accordance with certain aspects of the present disclosure.

FIG. 3 illustrates an example of a prototype printed circuit board (PCB) employing and antenna array configuration having eight (8) printed monopole antennas for use with the system, as shown in FIGS. 1 and 2, in accordance with certain aspects of the present disclosure.

FIG. 4 illustrates an example of a magnified view of a top end of the PCB, as shown in FIG. 3, in accordance with certain aspects of the present disclosure.

FIG. 5 illustrates an example of a graph of efficiency loss versus frequency for the antenna array configuration, as shown in FIG. 3, in accordance with certain aspects of the present disclosure.

FIG. 6 illustrates an example of a graph of correlation coefficients versus frequency for the antenna array configuration, as shown in FIG. 3, in accordance with certain aspects of the present disclosure.

FIG. 7 illustrates an example of a graph of Eigenvalues versus frequency for the antenna array configuration, as shown in FIG. 3, in accordance with certain aspects of the present disclosure.

FIG. 8 illustrates an example of a simulated printed circuit board (PCB) employing an antenna array configuration having five (5) printed monopole antennas and three (3) planar inverted F antennas (PIFA) for use with the system, as shown in FIGS. 1 and 2, in accordance with certain aspects of the present disclosure.

FIG. 9 illustrates an example of a magnified view of a top end of the PCB, as shown in FIG. 8, in accordance with certain aspects of the present disclosure.

FIG. 10 illustrates an example of a top, right, and rear perspective view of the PCB, as shown in FIG. 8, in accordance with certain aspects of the present disclosure.

FIG. 11 illustrates an example of a graph of return loss versus frequency for the antenna array configuration, as shown in FIG. 8, in accordance with certain aspects of the present disclosure.

FIG. 12 illustrates an example of a graph of coupling versus frequency for the antenna array configuration, as shown in FIG. 8, in accordance with certain aspects of the present disclosure.

FIG. 13 illustrates an example of a graph of efficiency versus frequency for the antenna array configuration, as shown in FIG. 8, in accordance with certain aspects of the present disclosure.

FIG. 14 illustrates an example of a graph of correlation coefficient versus frequency for the antenna array configuration, as shown in FIG. 8, in accordance with certain aspects of the present disclosure.

FIG. 15 illustrates an example of a graph of Eigenvalues versus frequency for the antenna array configuration, as shown in FIG. 8, in accordance with certain aspects of the present disclosure.

FIG. 16 illustrates an example of a simulated printed circuit board (PCB) employing an antenna array configuration having five (5) printed monopole antennas and three (3) donut antennas for use with the system, as shown in FIGS. 1 and 2, in accordance with certain aspects of the present disclosure.

FIG. 17 illustrates an example of a magnified view of a top end of the PCB, as shown in FIG. 16, in accordance with certain aspects of the present disclosure.

FIG. 18 illustrates an example of a top, right, and rear perspective view of the PCB, as shown in FIG. 16, in accordance with certain aspects of the present disclosure.

FIG. 19 illustrates an example of a graph of return loss versus frequency for the antenna array configuration, as shown in FIG. 16, in accordance with certain aspects of the present disclosure.

FIG. 20 illustrates an example of a graph of coupling versus frequency for the antenna array configuration, as shown in FIG. 16, in accordance with certain aspects of the present disclosure.

FIG. 21 illustrates an example of a graph of efficiency versus frequency for the antenna array configuration, as shown in FIG. 16, in accordance with certain aspects of the present disclosure.

FIG. 22 illustrates an example of a graph of correlation coefficient versus frequency for the antenna array configuration, as shown in FIG. 16, in accordance with certain aspects of the present disclosure.

FIG. 23 illustrates an example of a graph of Eigenvalues versus frequency for the antenna array configuration, as shown in FIG. 16, in accordance with certain aspects of the present disclosure.

FIG. 24 illustrates an example of a prototype printed circuit board (PCB) employing an antenna array configuration having six (6) chip antennas and two (2) planar inverted F antennas (PIFA) for use with the system, as shown in FIGS. 1 and 2, in accordance with certain aspects of the present disclosure.

FIG. 25 illustrates an example of a magnified view of a top end of the PCB, as shown in FIG. 24, in accordance with certain aspects of the present disclosure.

FIG. 26 illustrates an example of a graph of efficiency loss versus frequency for the antenna array configuration, as shown in FIG. 24, in accordance with certain aspects of the present disclosure.

FIG. 27 illustrates an example of a graph of S-parameters (e.g., return loss and isolation) versus frequency for two adjacent antennas in the antenna array configuration, as shown in FIG. 24, in accordance with certain aspects of the present disclosure.

FIG. 28 illustrates an example of a graph of S-parameters (e.g., return loss and isolation) versus frequency for two adjacent antennas in the antenna array configuration, as shown in FIG. 24, in accordance with certain aspects of the present disclosure.

FIG. 29 illustrates an example of a graph of correlation coefficient versus frequency for the antenna array configuration, as shown in FIG. 24, in accordance with certain aspects of the present disclosure.

FIG. 30 illustrates an example of a graph of Eigenvalues versus frequency for the antenna array configuration, as shown in FIG. 24, in accordance with certain aspects of the present disclosure.

FIG. 31 illustrates an example of a laptop employing a printed circuit board (PCB) employing sixteen (16) chip antennas for use with the system, as shown in FIGS. 1 and 2, in accordance with certain aspects of the present disclosure.

FIG. 32 illustrates a magnified view of top right corner of the example shown in FIG. 31, in accordance with certain aspects of the present disclosure.

FIG. 33 illustrates an example of a graph of efficiency loss versus frequency for the antenna array configuration, as shown in FIG. 31, in accordance with certain aspects of the present disclosure.

FIG. 34 illustrates an example of a graph of S-parameters (e.g., return loss and isolation) versus frequency for two adjacent antennas in the antenna array configuration, as shown in FIG. 31, in accordance with certain aspects of the present disclosure.

FIG. 35 illustrates an example of a graph of S-parameters (e.g., return loss and isolation) versus frequency for two adjacent antennas in the antenna array configuration, as shown in FIG. 31, in accordance with certain aspects of the present disclosure.

FIG. 36 illustrates an example of a graph of correlation coefficient versus frequency for the antenna array configuration, as shown in FIG. 31, in accordance with certain aspects of the present disclosure.

FIG. 37 illustrates an example of a graph of Eigenvalues versus frequency for the antenna array configuration, as shown in FIG. 31, in accordance with certain aspects of the present disclosure.

FIG. 38 illustrates an example of a graph of Eigenvalues versus frequency for eight chip antennas across the top of the antenna array configuration, as shown in FIG. 31, in accordance with certain aspects of the present disclosure.

FIG. 39 illustrates an example of a graph of Eigenvalues versus frequency for eight chip antennas across the side of the antenna array configuration, as shown in FIG. 31, in accordance with certain aspects of the present disclosure.

FIG. 40 illustrates an example of a graph of Eigenvalues versus frequency for eight chip antennas around the corner of the antenna array configuration, as shown in FIG. 31, in accordance with certain aspects of the present disclosure.

FIG. 41 illustrates an example of a graph of Eigenvalues versus frequency for eight odd numbered position chip antennas around the corner of the antenna array configuration, as shown in FIG. 31, in accordance with certain aspects of the present disclosure.

FIG. 42 illustrates an example of a laptop employing a printed circuit board (PCB) employing an antenna array configuration having eight (8) monopole antennas for use with the system, as shown in FIGS. 1 and 2, in accordance with certain aspects of the present disclosure.

FIG. 43 illustrates a magnified view of top right corner of the example shown in FIG. 42, in accordance with certain aspects of the present disclosure.

### DETAILED DESCRIPTION

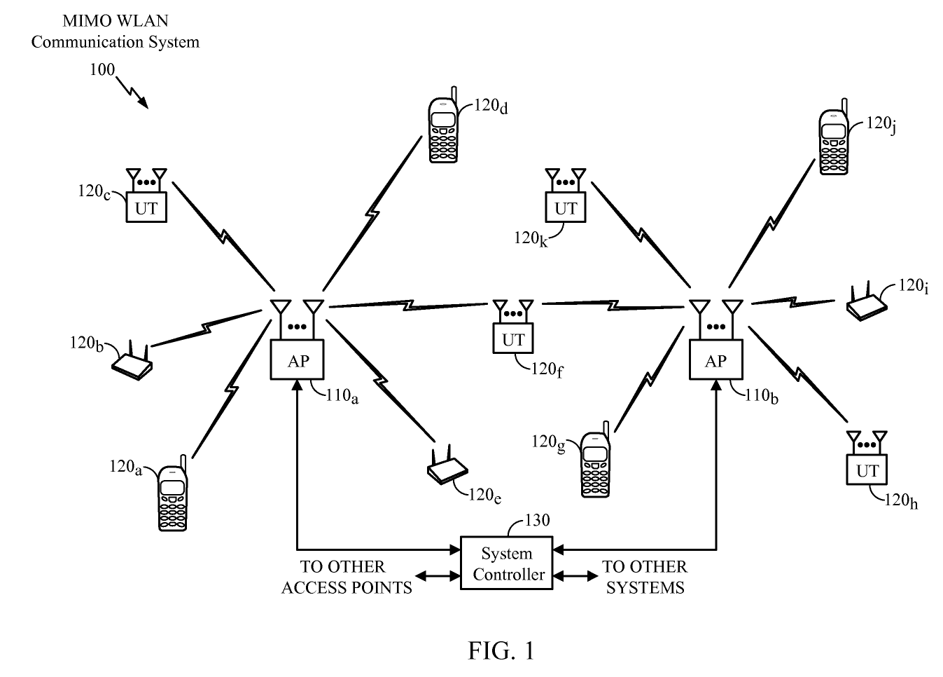

FIG. 1 illustrates an example of a multiple in multiple out (MIMO) wireless local area network (WLAN) communication system with access points (APs) and user terminals (UTs), in accordance with certain aspects of the present disclosure. For simplicity, only one access point 110 is shown in FIG. 1. As used herein, the term access point generally refers to a fixed station that communicates with the user terminals and may also be referred to as a base station, node B, or some other terminology. A system controller 130 couples to and provides coordination and control for the access points to other access points or other systems. A user terminal 120 may be fixed or mobile and may also be referred to as a mobile station, a wireless device, a portable device, a communication device, or some other terminology. A user terminal may communicate with an access point, in which case the roles of access point and user terminal are established. A user terminal may also communicate peer-to-peer with another user terminal.

The MIMO system 100 may be a time division duplex (TDD) system or a frequency division duplex (FDD) system. For a TDD system, the downlink and uplink share the same frequency band. For an FDD system, the downlink and uplink use different frequency bands. The downlink is the communication link from the access points to the user terminals, and the uplink is the communication link from the user terminals to the access points. MIMO system 100 may also utilize a single carrier or multiple carriers for data transmission.

In order to increase capacity and data throughput, an access point and user terminals may be equipped with higher order antenna arrays, such as eight or sixteen antennas with different polarization directions. For certain aspects of the present disclosure, the user terminal 120 may be a portable device, a portable computer (e.g., laptop), a cellular phone, a peripheral, a modem, a smart phone, a camera, a camcorder, a computer device, a wireless device, a high definition (HD) television set, or any other type of electronic device, etc.

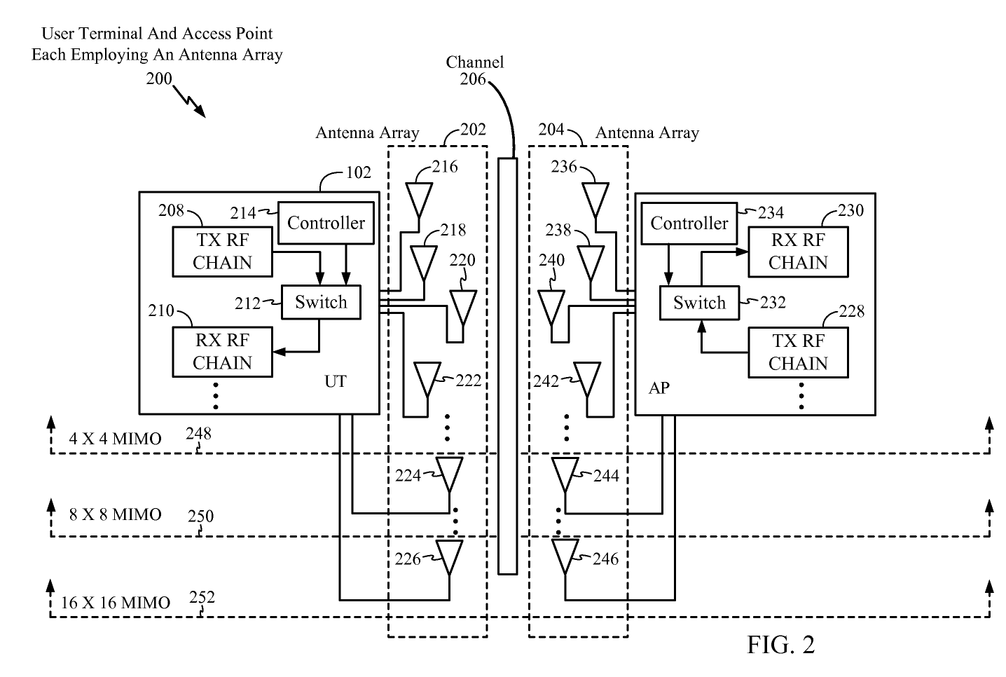

FIG. 2 illustrates an example of further details of an access point 110 and a user terminal 102, each employing an antenna array 204 and 202, respectively, as shown in the system of FIG. 1, in accordance with certain aspects of the present disclosure. The access point 110 and the user terminal 102 communicate over a communication channel 206, otherwise referred to as a link, path, signal, etc.

The user terminal 102 includes, among other elements well known but not shown, a transmitter (Tx) radio frequency (RF) chain (i.e., path of transmitter elements) 208, a receiver (Rx) RF chain (i.e., a path of receiver elements) 210, a controller 214, and a switch 212. The user terminal employs the antenna array 202, including antennas 216-226.

In the user terminal 102, antenna 216 in the antenna array 202 is electrically coupled to the switch 212, otherwise referred to as an antenna switch. The controller 214 controls the switch 212 (as well as other elements, such as the Tx RF chain 208 and the Rx RF chain 210), to selectively and electrically couple the antenna 216 to the Tx RF chain 208 and/or the Rx RF chain 210. Methods or processes for controlling the switch 212, including methods for communicating in MIMO WLAN systems 100, are well known to those skilled in the art of such systems.

In the user terminal 102, each antenna 216-226 is electrically coupled to a different set of set of RF chains, wherein each RF chain includes a switch 212, a Tx RF Chain 208 and an Rx RF chain 210. Therefore, in a user terminal 102 employing four antennas, the user terminal 102 also employs four different sets of RF chains. Further, for example, in a user terminal 102 employing eight antennas, the user terminal 102 also employs eight different sets of RF chains.

The access point 110 includes, among other elements well known but not shown, a transmitter (Tx) radio frequency (RF) chain (i.e., path of transmitter elements) 228, a receiver (Rx) RF chain (i.e., a path of receiver elements) 230, a controller 234, and a switch 232. The user terminal employs the antenna array 204, including antennas 236-246.

In the access point 110, antenna 236 in the antenna array 204 is electrically coupled to the switch 232, otherwise referred to as an antenna switch. The controller 234 controls the switch 232 (as well as other elements, such as the Tx RF chain 228 and the Rx RF chain 230), to selectively and electrically couple the antenna 236 to the Tx RF chain 228 and/or the Rx RF chain 230. Methods or processes for controlling the switch 234, including methods for communicating in MIMO WLAN systems 100, are well known to those skilled in the art of such systems.

In the access point 110, each antenna 236-246 is electrically coupled to a different set of set of RF chains, wherein each RF chain includes a switch 232, a Tx RF chain 228 and an Rx RF chain 230. Therefore, in an access point 110 employing four antennas, the access point 110 also employs four different sets of RF chains. Further, for example, in an access point 110 employing eight antennas, the access point 110 also employs eight different sets of RF chains.

In a MIMO system employing TDD, each of the user terminal 102 and the access point 110 employ the switch 212 and the switch 232, respectively, as shown in FIG. 2. Alternatively, in a MIMO system employing FDD, each of the user terminal 102 and the access point 110 each employ a duplexer (not shown in FIG. 2). Since the duplexer separates the signals by frequency, and not by time, the controllers 214 and 234 are not need as controls for a duplexer.

Generally, MIMO systems (e.g., for WLAN or otherwise) employ antenna arrays in groups of 2, 4, 8, 16, 32, 64, etc., although any number of antenna may be used. For example, as shown in FIG. 2, a MIMO system 100 using four individual antennas in each of the antenna arrays 202 (i.e., antennas 216-222) and 204 (i.e., antennas 236-242) for the user terminal 102 and the access point 110, respectively, is referred to as a 4×4 MIMO system 248. Similarly, by extension, a MIMO system 100 using eight individual antennas in each of the antenna arrays 202 (i.e., antennas 216-224) and 204 (i.e., antennas 236-244) for the user terminal 102 and the access point 110, respectively, is referred to as a 8×8 MIMO system 250. Further, by extension, a MIMO system 100 using sixteen individual antennas in each of the antenna arrays 202 (i.e., antennas 216-226) and 204 (i.e., antennas 236-246) for the user terminal 102 and the access point 110, respectively, is referred to as a 16×16 MIMO system 252.

Any number of antennas may be employed by the user terminal 102 and the access point 110 in the same MIMO system 100. For example, the user terminal 102, embodied as a portable phone handset, may have four antennas. The user terminal 102, embodied as a laptop, may have eight antennas. The user terminal 102, embodied as a high definition television, may have sixteen antennas. Further, for example, the access point 110 may have any number of antennas, such as 2, 3, 4, 5, . . . 16, . . . , etc. In combination, the user terminal 102 and the access point 110 may employ a different number of antennas. For example, the user terminal 102 may employ 2 antennas and the access point may employ 3 antennas. Further, for example, the user terminal 102 may employ four antennas and the access point may employ eight or sixteen antennas. Therefore, the MIMO system 100 is not limited to the same and/or an even number of antennas for each of the user terminal 102 and the access point 110, as shown in FIG. 2 as 4×4, 8×8, and 16×16.

Although it is known that increasing the number of antenna elements in an antenna array in a MIMO system increases data throughput and efficiency, mechanical and electrical engineering challenges exist to employ increased number of antenna elements in progressively smaller, lower cost devices, especially in user terminals 102 implemented as mobile communication devices, such as cellular telephones, printed circuit cards, and laptops, for example.

Exemplary Antenna Arrays

The present disclosure describes six examples of configurations for an antenna array employed on the user terminal and/or on the access point, as shown in FIGS. 1 and 2. The example antenna array configurations are on a printed circuit board (PCB) embodied in a printed circuit (PC) card or in a laptop. The example antenna array configurations have been tested using real or simulated channel measurements. The example antenna array configurations support 8×8 and 16×16 MIMO antenna arrays embodied in a user terminal 120, as well as space division multiple access (SDMA) using sixteen (16) antennas with an access point 110. Concepts embodied within the various examples include using different types of antennas with different field patterns positioned at different locations and different directions to achieve a desired performance in a relatively small area for a desired cost.

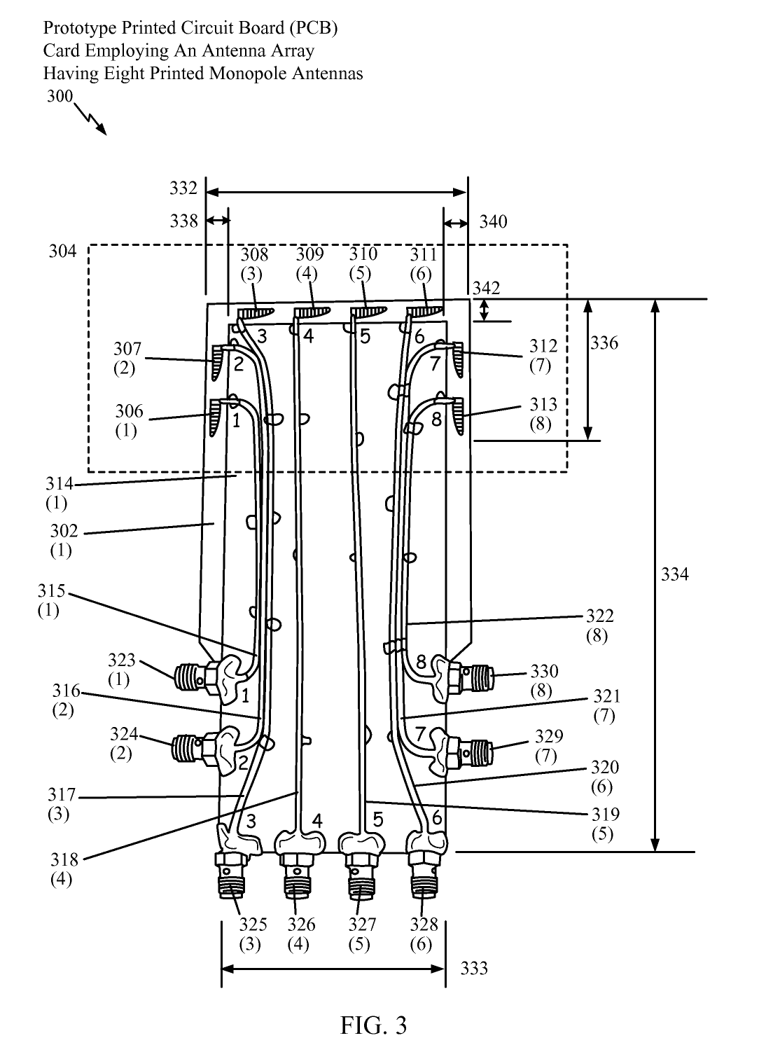

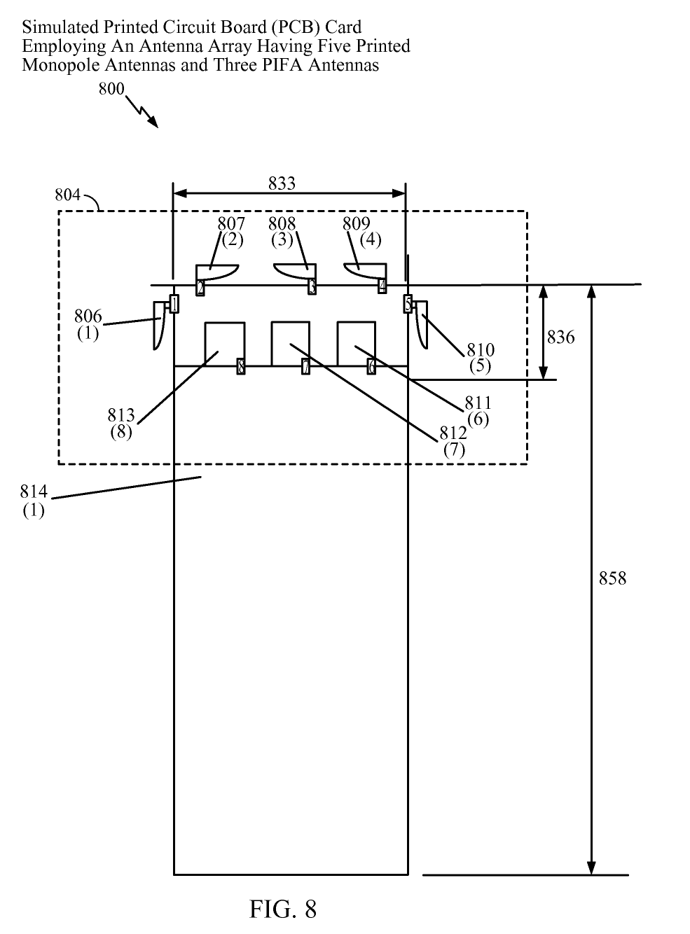

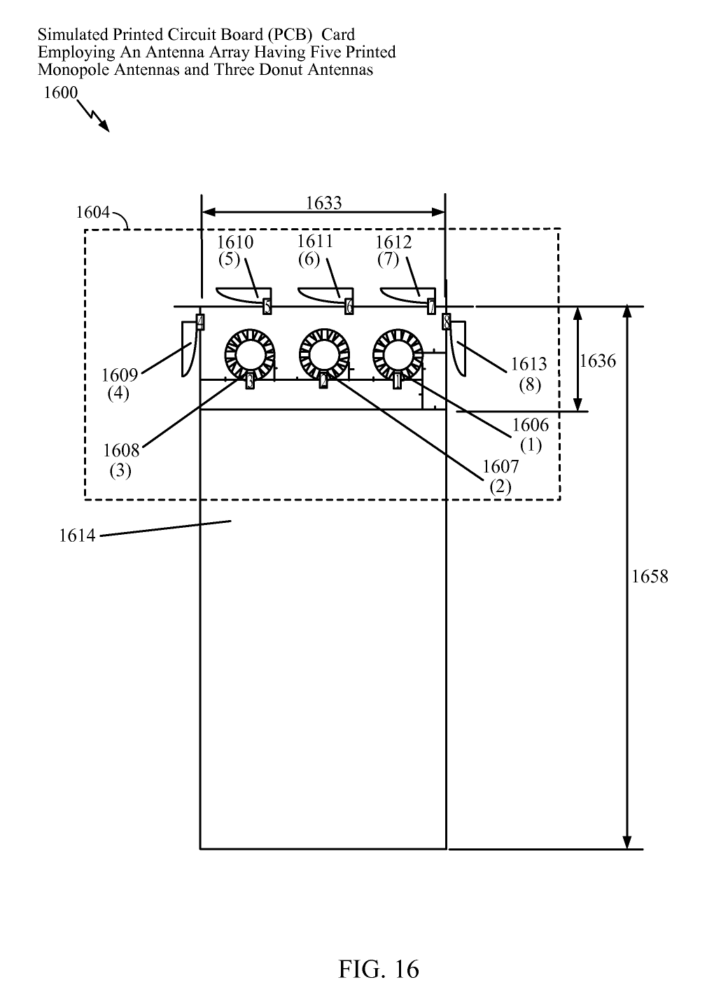

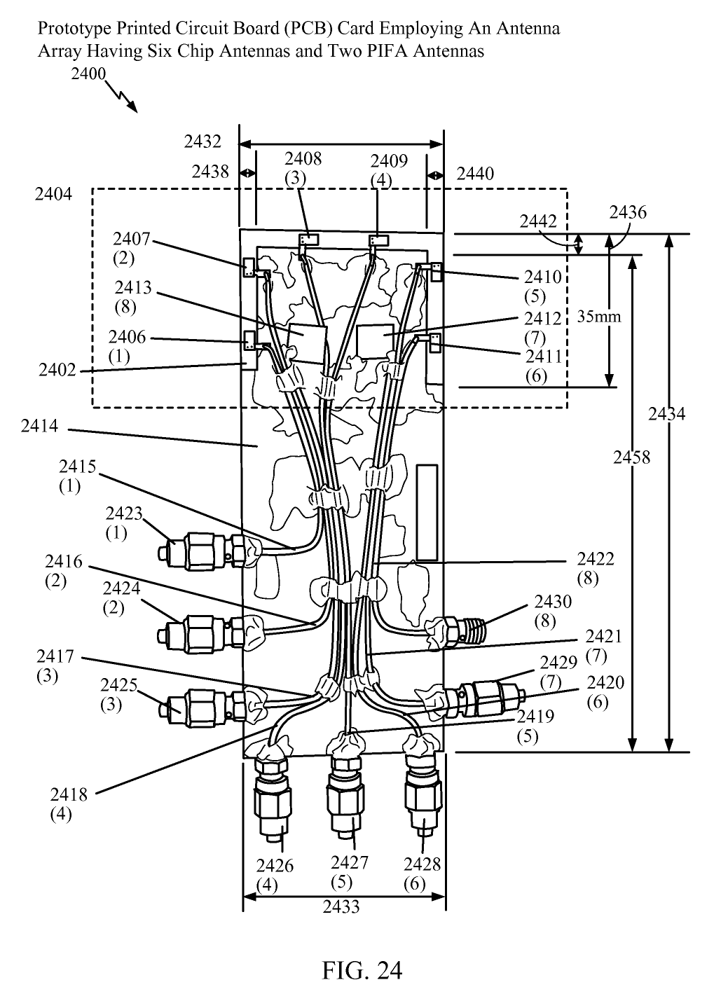

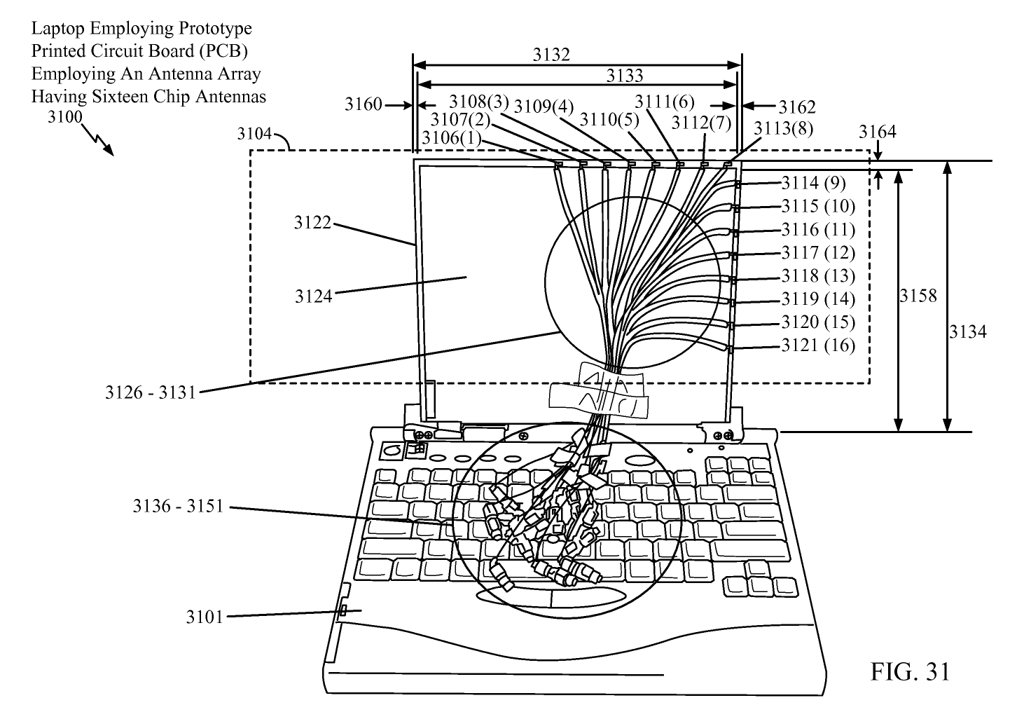

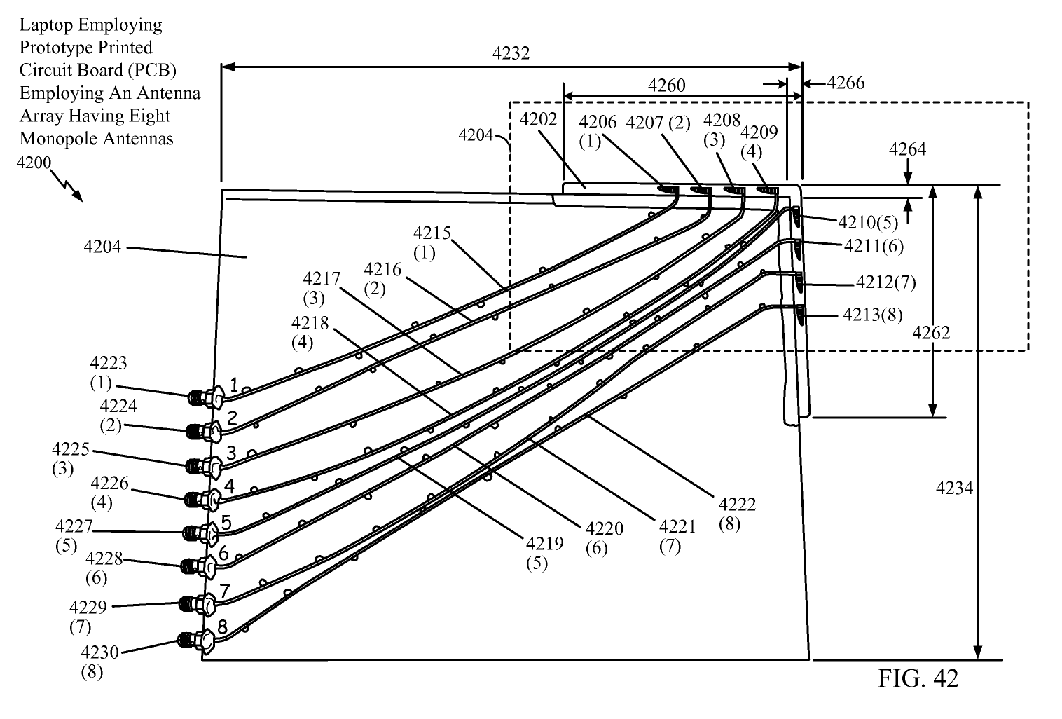

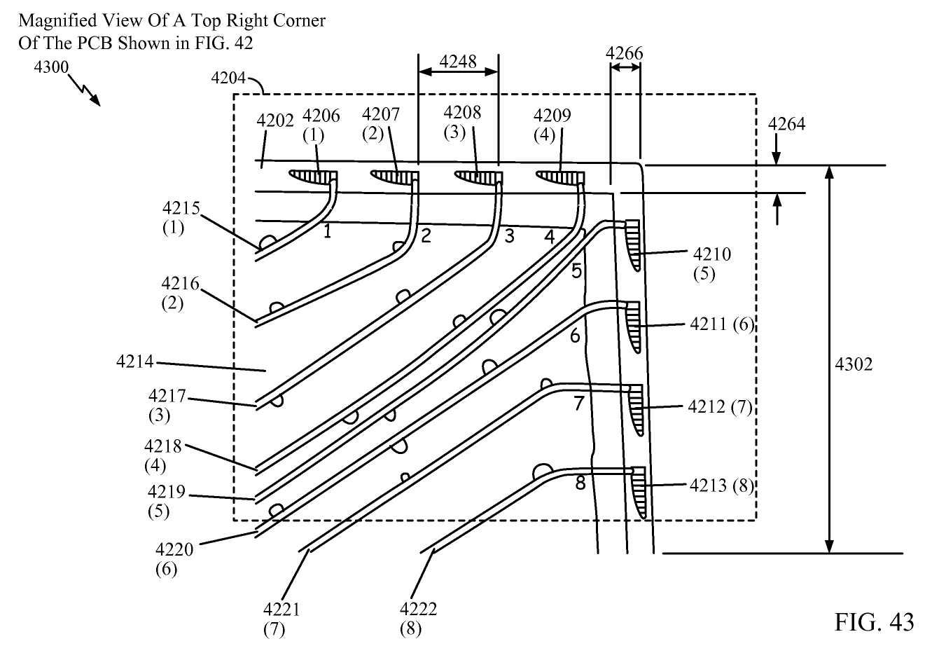

Generally, FIGS. 3 to 7 illustrate an example of a prototype printed circuit board (PCB) employing and antenna array configuration having eight (8) printed monopole antennas for use with the system, as shown in FIGS. 1 and 2, and associated performance graphs to support 8×8 MIMO. FIGS. 8 to 15 illustrate an example of a simulated PCB employing an antenna array configuration having five (5) printed monopole antennas and three (3) planar inverted F antennas (PIFA) for use with the system 100, as shown in FIGS. 1 and 2, and associated performance graphs to support 8×8 MIMO. FIGS. 16-23 illustrate an example of a simulated PCB employing an antenna array configuration having five (5) printed monopole antennas and three (3) donut antennas for use with the system 100, as shown in FIGS. 1 and 2, and associated performance graphs to support 8×8 MIMO. FIGS. 24-30 illustrate an example of a prototype PCB employing an antenna array configuration having six (6) chip antennas and two (2) planar inverted F antennas (PIFA) for use with the system 100, as shown in FIGS. 1 and 2, and associated performance graphs to support 8×8 MIMO. FIGS. 31-41 illustrate an example of a laptop employing a PCB employing an antenna array configuration having sixteen (16) chip antennas for use with the system 100, as shown in FIGS. 1 and 2, and associated performance graphs to support 16×16 MIMO. FIGS. 42 and 43 illustrate an example of a laptop employing a PCB employing an antenna array configuration having eight (8) monopole antennas for use with the system 100, as shown in FIGS. 1 and 2 to support 8×8 MIMO.

Some of the examples illustrated are lab built prototypes (e.g., FIGS. 3-4, 24-25, 31-32, and 42-43), and some of the examples are computer simulations (i.e., a particular software program) (e.g., FIGS. 8-10, and 16-18). The lab built prototypes provide a relatively accurate representation of high volume production parts or devices, with regards to shape, size, location, position, etc., for each of the antennas, ground plane, PCB, etc. The electrically conductive paths (e.g., coaxial paths) and connectors (e.g., coaxial connectors) connected to each path, however, are somewhat large and expensive, and not representative of typical, known embodiments of high volume production parts or devices. Production embodiments may include conductive paths represented as coaxial traces printed on the PCB, and connectors represented as miniature, low profile coaxial connectors. Nevertheless, the prototype conductive paths and connectors provide a prototype that may be readily built to test the electrical performance of the prototypes to see if the prototypes meet production performance requirements.

The computer simulations also provide a relatively accurate representation of high volume production parts or devices, with regards to shape, size, location, position, etc., for each of the antennas, ground plane, PCB, etc. Some of the computer simulations have been tested and compared against actual physical prototype designs, although such comparisons are not shown and described in this disclosure. The comparisons, however, indicate that the computer simulations are very close or nearly identical to the actual physical prototype designs, which verifies the quality, accuracy, and integrity of the computer simulations. Armed with confidence in the computer simulations, designers may build and test various simulated antenna array configurations much faster than building and testing actual physical prototype designs. Further, the computer simulations do not show the electrically conductive paths and connectors for each antenna in the array because such electrical information is embodied in the computer simulation itself, and is not necessary to illustrate mechanically. In summary, each of the actual physical prototype designs and the computer simulations advantageously provide a relatively accurate representation of high volume production parts or devices, both mechanically and electrically.

For certain examples, channel measurements may be performed with the Antenna Measurement Platform (AMP) 4×4 MIMO channel sounder developed, for example, at Qualcomm, Inc., and enhanced to enable 8×8 and 16×16 MIMO antenna configurations and channel measurements.

In order to satisfy the system requirements and choose a suitable antenna, system engineers evaluate an antenna's performance. Typical descriptions, metrics or parameters used in evaluating an antenna include, for example, the bandwidth, return loss, isolation, correlation, Eigenvalues, mechanical design, size, cost, and manufacturability, etc.

Bandwidth may be described as the range of frequencies within which the performance of the antenna, with respect to some characteristic, conforms to a specified standard. In other words, bandwidth depends on the overall effectiveness of the antenna through a range of frequencies, so these parameters must be understood to fully characterize the bandwidth capabilities of an antenna. In practice, bandwidth is typically determined by measuring a characteristic such as SWR or radiated power over a frequency range of interest. For example, the SWR bandwidth is typically determined by measuring the frequency range where the SWR is less than 2:1.

Return loss or reflection loss is the reflection of signal power resulting from the insertion of a device, such as an antenna, in a transmission line or optical fiber. It is usually expressed as a ratio in dB relative to the transmitted signal power.

Isolation is the electromagnetic or electrical separation of one electrical element from another, such as among or between multiple antennas in a MIMO communications system.

In probability theory and statistics, correlation (often measured as a correlation coefficient) indicates the strength and direction of a linear relationship between two random variables. A correlation matrix of n random variables X₁, . . . , Xₙ is the n×n matrix whose i,j entry is corr(Xᵢ, Xⱼ). If the measures of correlation used are product-moment coefficients, the correlation matrix is the same as a covariance matrix of the standardized random variables Xᵢ/SD(Xᵢ) for i=1, . . . , n. Consequently it is necessarily a positive-semidefinite matrix. The correlation matrix is symmetric because the correlation between Xᵢ and Xⱼ is the same as the correlation between Xⱼ and Xᵢ. A covariance matrix is a matrix of covariances between elements of a vector. It is the natural generalization to higher dimensions of the concept of the variance of a scalar-valued random variable.

In linear algebra, a linear transformation between finite-dimensional vector spaces can be expressed as a matrix, which is a rectangular array of numbers arranged in rows and columns. Standard methods may be used for finding eigenvalues, eigenvectors, and eigenspaces of a given matrix. In mathematics, given a linear transformation, an eigenvector of that linear transformation is a nonzero vector which, when that transformation is applied to it, may change in length, but not direction. For each eigenvector of a linear transformation, there is a corresponding scalar value called an eigenvalue for that vector, which determines the amount the eigenvector is scaled under the linear transformation. For example, an eigenvalue of +2 means that the eigenvector is doubled in length and points in the same direction. An eigenvalue of +1 means that the eigenvector is unchanged, while an eigenvalue of −1 means that the eigenvector is reversed in direction. An eigenspace of a given transformation for a particular eigenvalue is the set of the eigenvectors associated to this eigenvalue, together with the zero vector (which has no direction).

Exemplary Antenna Arrays

1. PCMCIA Card Having a PCB with Eight (8) Printed Monopole Antennas.

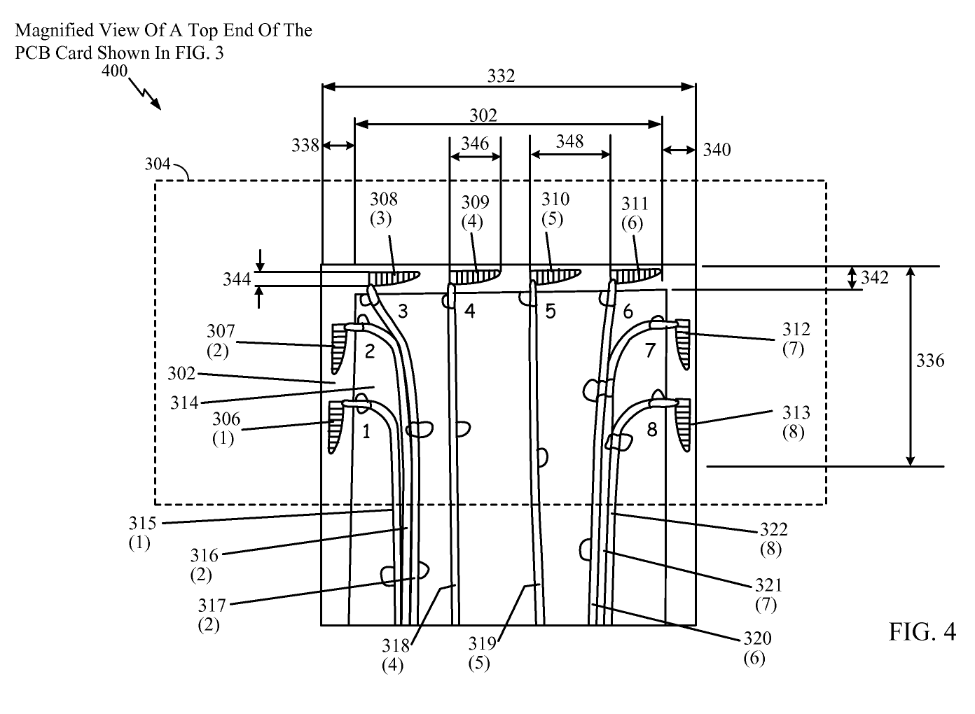

FIG. 3 illustrates an example of a prototype personal computer memory card international association (PCMCIA) card 300 employing a PCB 302 and antenna array configuration 304 for use with the system 100, as shown in FIGS. 1 and 2, in accordance with certain aspects of the present disclosure. FIG. 4 illustrates an example of a magnified view 400 of a top end of the PCMCIA card 300, as shown in FIG. 3, in accordance with certain aspects of the present disclosure. The PCMCIA card 300 may be of the type that connects to other electronic devices, such as a laptop computer, to provide the electronic device with radio frequency (RF) wireless communication capability.

The PCMCIA card 300 generally includes a printed circuit board 302, a ground plane 314, eight (8) printed monopole antennas 306-313 (also labeled 1-8, respectively) forming the antenna array 304, eight (8) electrically conductive paths 315-322 (also labeled 1-8, respectively), eight (8) eight connectors 323-330 (also labeled 1-8, respectively).

Each printed monopole antenna is electrically connected to a corresponding connector via a corresponding path. Antenna 306 is connected to connector 323 via path 315. Antenna 307 is connected to connector 324 via path 316. Antenna 308 is connected to connector 325 via path 317. Antenna 309 is connected to connector 326 via path 318. Antenna 310 is connected to connector 327 via path 319. Antenna 311 is connected to connector 328 via path 320. Antenna 312 is connected to connector 329 via path 321. Antenna 313 is connected to connector 330 via path 322.

The PCB 302 may have a width dimension 332 of 60 mm and a length dimension 334 of 125 mm. The ground plane 314 may be centered within a distal end surface of the PCB 302 permitting a non-grounded border portion of the PCB to have a left border dimension 338 of 5 mm, a top border dimension 342 of 5 mm, and a right border dimension 340 of 5 mm. The antenna array 304, located at the distal end of the PCB 302 has a length dimension 336 of about 32 mm. In FIG. 4, each monopole antenna 306-313 has a width dimension 344 of 2.3 mm and a length dimension 346 of 8.5 mm. In FIG. 4, a separation distance 348 between each monopole antenna 306-313 is about 13 mm, corresponding to approximately ¼ wavelength. Other dimensions or features, such as these described as well as other features, shown in FIGS. 3 and 4, may be permitted within the scope of the present invention.

The PCB 302 advantageously supports the ground plane 314 and the printed monopole antennas 306-313 in a common plane on a surface of the PCB 302. Alternatively, when the ground plane and the printed monopole antennas 306-313 have a sufficient thickness (e.g., thicker than the thickness typically printed on a PCB) or other self-supporting mechanical structure (e.g., folds, bends, ridges, etc.) the ground plane and the printed monopole antennas 306-313 may support itself, without the use of the PCB 302.

Regardless of whether a supporting PCB 302 is used in combination with the ground plane 314 or whether the ground plane 314 is used without the PCB 302, each of the printed monopole antennas 306-313 may be located in any plane relative to a plane containing the PCB 302 and/or the ground plane 314. In the example shown in FIGS. 3 and 4, the printed monopole antennas 306-313 are all shown and described to be in the same plane as the ground plane 314, since the printed monopole antennas 306-313 and the ground plane 314 are manufactured during the same process. Alternatively, each of the printed monopole antennas 306-313 may be located in any position within an imaginary sphere of space surrounding each of the printed monopole antennas 306-313.

Many positions of each of the printed monopole antennas 306-313 may be provided of which a few are described to summarize this concept. In one example, adjacent printed monopole antennas 306-313 may be printed on opposite sides of the same PCB 302. In this example, the printed monopole antennas 306-313 have the same relative locations as shown in FIGS. 3 and 4 when looking at the PCB 302, as shown in FIGS. 3 and 4. However, the even numbered printed monopole antennas 306, 308, 310, and 312 are located on the front side of the PCB 302, as shown in FIGS. 3 and 4, and the odd numbered printed monopole antennas 307, 309, 311, and 313 are located on the rear side of the PCB 302, which is different from that shown in FIGS. 3 and 4. The odd numbered printed monopole antennas 307, 309, 311, and 313 may be located on the rear side of the PCB 302 by using PCB feed thru holes, for example, wherein such holes are well known to those skilled in the PCB art. In this example, the even and odd numbered antenna elements are further separated by the thickness of the PCB 302, which may improve performance characteristics of the antenna array 304.

In another example, when the PCB 302 is not used, even and odd numbered antenna elements may be positioned at various angles relative to each other within a range of 0 to 360 degrees relative to a plane of the ground plane 314. In FIGS. 3 and 4, for example, each of the printed monopole antennas 306-313 are located at about +180 degrees relative to a front surface of the ground plane 314. In an alternative example, the even numbered printed monopole antennas 306, 308, 310, and 312 may be located at about +120 degrees relative to the a front surface of the ground plane 314, and the odd numbered printed monopole antennas 307, 309, 311, and 313 may be located at about +240 degrees relative to the a front surface of the ground plane 314. In this example, the even and odd numbered antenna elements are further separated by an angle of about +120 degrees, which may improve performance characteristics of the antenna array 304.

In yet another example, when the PCB 302 is not used, even and odd numbered antenna elements may be positioned at various angles relative to each other within a range of 0 to 360 degrees relative to another plane which is perpendicular to the plane of the ground plane 314. In this example, the printed monopole antennas 306-313 may be conceptually be thought of as being twisted in an out of the plane of the ground plane 314, as shown in FIGS. 3 and 4. In FIGS. 3 and 4, for example, each of the printed monopole antennas 306-313 are located at about 0 degrees relative to a front surface of the ground plane 314. In an alternative example, the even numbered printed monopole antennas 306, 308, 310, and 312 may be located at about +90 degrees relative to the a front surface of the ground plane 314, and the odd numbered printed monopole antennas 307, 309, 311, and 313 may be located at about −90 degrees relative to the a front surface of the ground plane 314. In this example, the even and odd numbered antenna elements are further separated by an angle of about +180 degrees, which may improve performance characteristics of the antenna array 304.

Each of these examples are not meant to be limited in any way, including to a particular antenna type of construction, and may be used with various antenna types and constructions, such as a ceramic chip package illustrated in FIGS. 24, 25, 31, and 32. Further, each of these examples are not meant to be limited to a particular antenna location or position. For example, these examples are not limited to even an odd antenna elements, adjacent antenna elements, etc. Further, the angles of the antenna elements may be positioned any angle relative to any plane and in any direction, thereby including all positions and locations within an imaginary space (e.g., sphere, square, rectangle, etc.)

A monopole antenna may employ various shapes, dimensions, and configurations relative to the ground plane. As illustrated in FIGS. 3 and 4, the monopole antenna is provided as a “pointed or tapered flag” shape, having a short and flat shape at a proximate end of the antenna, which gradually tapers along first length side to a pointed shape at a distal end of the antenna. The second length side is long, flat and forms about a right angle with the short and flat shape at the proximate end of the antenna. The short and flat shape at a proximate end of the antenna connects to the corresponding path for each of the corresponding antennas. Alternatively, a monopole antenna may be formed in a ceramic chip package similar to those shown in FIGS. 24, 25, 31, and 32.

Individually, various design and engineering details for prototype and production versions of each of the printed circuit board 302 (e.g., FR4), the ground plane 314, the eight printed monopole antennas 306-313, the eight electrically conductive paths 315-322, and the eight (8) eight connectors 323-330, are well known to those skilled in the art of those individual elements.

The PCMCIA card 300 has two antennas 306-307 located along a left side of the card 300, four antennas 308-311 located along a top of the card 300, and two antennas 312 and 313 located along a right side of the card 300. Other configurations of the antenna array 304 are possible and may be used within the scope of the present invention.

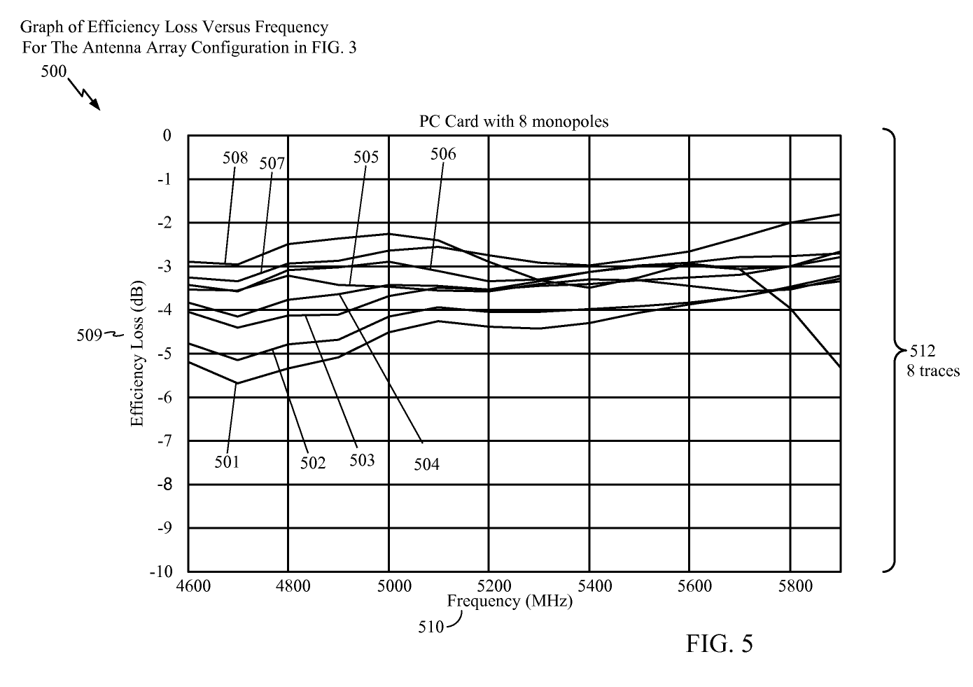

The antenna array 304, illustrated in FIGS. 3 and 4, advantageously permits the PCMCIA card 300, having dimensions compatible with industry standard dimensions (e.g., length and width), to be adapted for use in an 8×8 MIMO communication system 100. The antenna array 304, 8×8 for example, is small enough to fit on a distal end of the PCMCIA card 300 while provide an acceptable antenna radiation pattern, and other acceptable communications characteristics, as further described in FIGS. 5-7.

FIG. 5 illustrates an example of a graph 500 of efficiency loss 509 versus frequency 510 for the antenna array configuration 304, as shown in FIG. 3, in accordance with certain aspects of the present disclosure. The graph 500 represents efficiency loss 509 from 0 to −10 dB. The graph 500 represents frequency range from 4600 to 5800 MHz. A process for measuring efficiency loss 509 versus frequency 510 for an antenna array is well known to those skilled in the art of antenna array designs. FIG. 5 illustrates acceptable performance for efficiency loss 509 versus frequency 510 for the antenna array configuration 304.

The graph 500 illustrates eight traces 512, wherein each trace 501-508 corresponds to an efficiency loss 509 versus frequency 510 for one the antennas 306-313. In particular, traces 501, 502, 503, 504, 505, 506, 507, and 508 correspond to antennas 306-313, respectively.

The data illustrated in the graph 500 includes electrical loss of about 0.2 to 0.3 dB in each of the paths 315-322, which are constructed as coaxial cables in the prototype version of the PCMCIA card 300. Such electrical loss may not be present in production version of the PCMCIA card 300, wherein PCB traces on the PCB 302 are used to provide the paths 315-322. Therefore, the efficiency loss 509 for each antenna 306-313 versus frequency 510 may improve in the graph 500 by about 0.2 to 0.3 dB in a production version of the PCMCIA card 300.

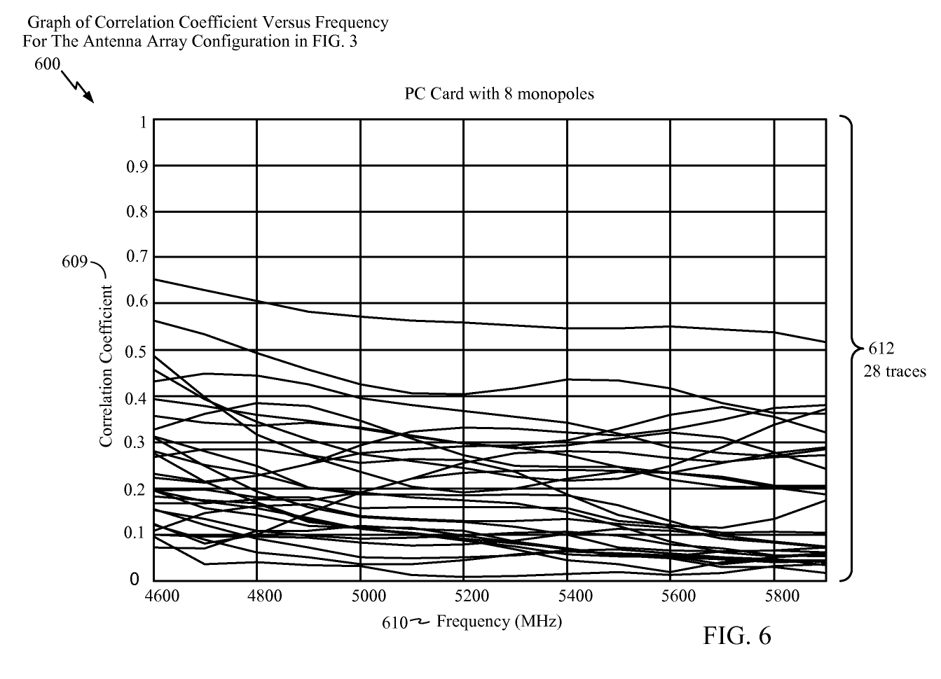

FIG. 6 illustrates an example of a graph 600 of correlation coefficients 609 versus frequency 610 for the antenna array configuration 304, as shown in FIG. 3, in accordance with certain aspects of the present disclosure. The graph 600 represents correlation coefficients 609 from 0 to 1. The graph 600 represents frequency range from 4600 to 5800 MHz. A process for measuring correlation coefficients 609 versus frequency 610 for an antenna array is well known to those skilled in the art of antenna array designs. FIG. 6 illustrates acceptable performance for correlation coefficients 609 versus frequency 610 for the antenna array configuration 304.

The graph 600 illustrates 28 traces 612, wherein each trace corresponds to correlation coefficients 609 versus frequency 610 among each pair of the antennas 306-313. For example, one trace represents correlation coefficients 609 versus frequency 610 between antennas 306 and 307, another represents correlation coefficients 609 versus frequency 610 between antennas 306 and 308, and so forth.

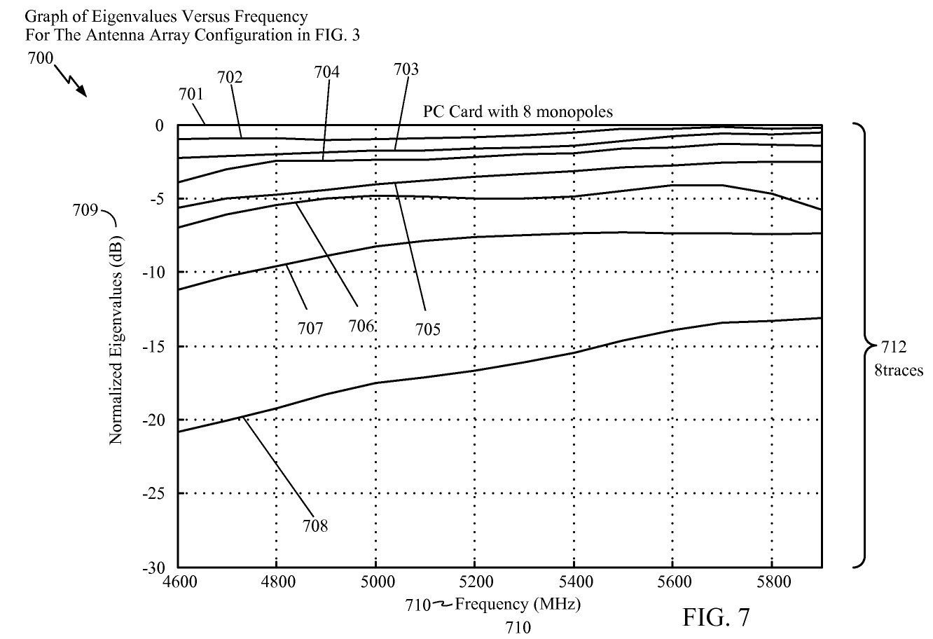

FIG. 7 illustrates an example of a graph 700 of Eigenvalues 709 of the covariance matrix versus frequency 710 for the antenna array configuration 304, as shown in FIG. 3, in accordance with certain aspects of the present disclosure. The graph 700 represents Eigenvalues 709 from 0 to −30 dB. The graph 700 represents frequency range from 4600 to 5800 MHz. A process for calculating Eigenvalues 709 versus frequency 710 from the radiation patterns of an antenna array is well known to those skilled in the art of antenna array designs. FIG. 7 illustrates acceptable performance for Eigenvalues 709 versus frequency 710 for the antenna array configuration 304.

The graph 700 illustrates eight traces 712, wherein each trace corresponds to Eigenvalues 709 versus frequency 710 among the antennas 306-313. The first trace 701 is normalized to 0 dB. In particular, traces 701, 702, 703, 704, 705, 706, 707, and 708 are sorted according to their magnitude.

2. PCMCIA Card Having a PCB with Five Monopole Antennas and Three PIFAs.

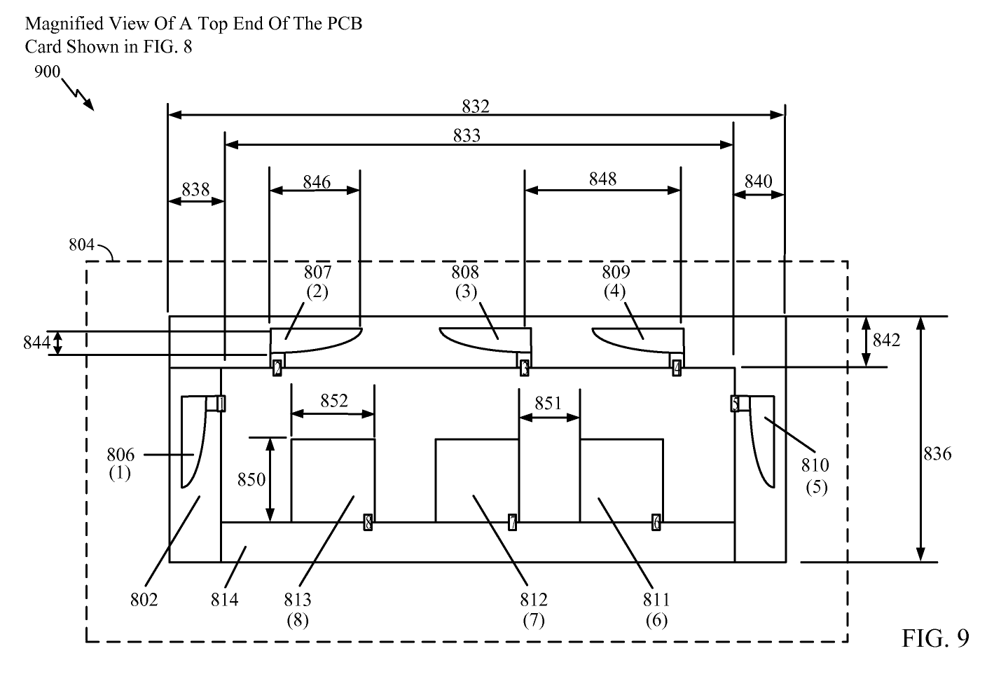

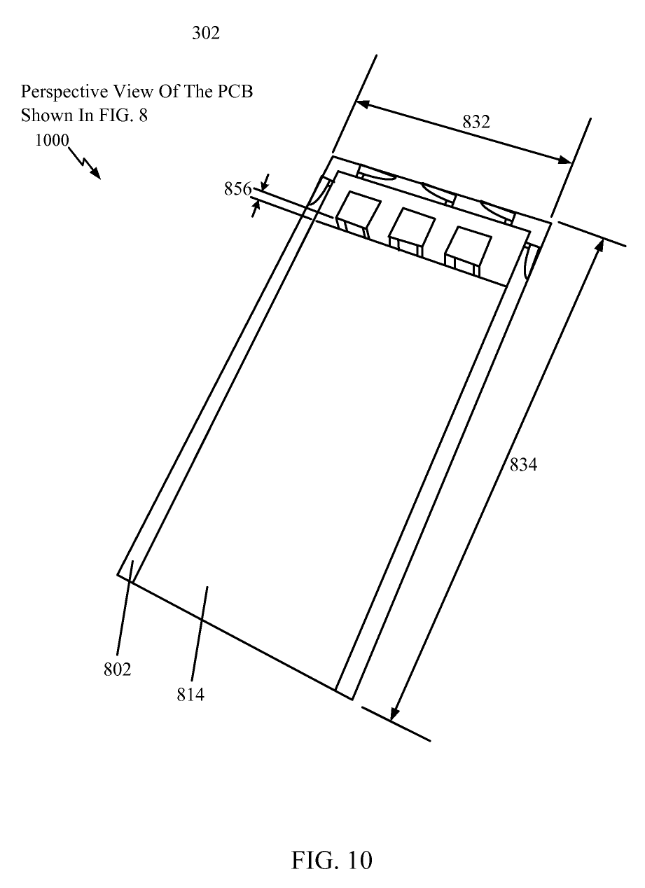

FIG. 8 illustrates an example of a simulated PCMCIA card 800 employing an antenna array configuration 804 having five (5) printed monopole antennas 806-810 and three (3) planar inverted F antennas (PIFA) 811-813 for use with the system 100, as shown in FIGS. 1 and 2, in accordance with certain aspects of the present disclosure. FIG. 9 illustrates an example of a magnified view 900 of a top end of the PCMCIA card 800, as shown in FIG. 8, in accordance with certain aspects of the present disclosure. FIG. 10 illustrates an example of a top, right, and rear perspective view of the PCMCIA card 300, as shown in FIG. 8, in accordance with certain aspects of the present disclosure. The PCMCIA card 800 may be of the type that connects to other electronic devices, such as a laptop computer, to provide the electronic device with radio frequency (RF) wireless communication capability.

The PCMCIA card 800 generally includes a printed circuit board 802, a ground plane 814, and five (5) printed monopole antennas 806-810 (also labeled 1-5, respectively) and three PIFAs 811-813 (also labeled 6-8, respectively), wherein all eight antennas together form the antenna array 804. Not shown but electrically simulated in FIGS. 8-10 are eight (8) electrically conductive paths. Each printed monopole antenna is of the type described with reference to FIGS. 3 and 4 hereinabove.

The PCB 802 may have a width dimension 832 of 58 mm and a length dimension 834 of 114 mm. The ground plane 814 may have a width dimension 833 of 50 mm and a length dimension 858 of 110 mm. The ground plane 814 may be centered within a distal end surface of the PCB 802 permitting a non-grounded border portion of the PCB to have a left border dimension 838 of 4 mm, a top border dimension 842 of 4 mm, and a right border dimension 840 of 4 mm. The antenna array 304, located at the distal end of the PCB 302 has a length dimension 836 of about 16 mm. In FIG. 4, each monopole antenna 306-313 has a width dimension 844 of 2.3 mm and a length dimension 846 of 8.5 mm. In FIG. 4, a separation distance 848 between each monopole antenna 806-810 is about 15 mm, corresponding to approximately ¼ wavelength. The PIFAs are located a height dimension 856 of 5 mm above the ground plane 814. Each of the PIFAs has a length dimension 852 of 8 mm and a width dimension 850 of 8 mm. Adjacent PIFAs may be separated by a separation distance 851 of 14 mm. Other dimensions or features, such as these described as well as other features, shown in FIGS. 8-10, may be permitted within the scope of the present invention.

PIFAs are derived from a quarter-wave half-patch antenna. In PIFAs, the shorting plane of the half-patch is reduced in length which decreases the resonance frequency. Often PIFAs have multiple branches to resonate at the various frequency bands, such as those used in cellular applications. In some configurations, grounded parasitic elements are used to enhance the radiation bandwidth characteristics of PIFAs. PIFA antennas may have more bandwidth and better efficiency than chip antennas.

Individually, various design and engineering details for prototype and production versions of each of the printed circuit board 802 (e.g. FR4), the ground plane 814, the five printed monopole antennas 806-810, the three PIFAs 811-813, the eight electrically conductive paths (not shown, but simulated), are well known to those skilled in the art of those individual elements.

The PCMCIA card 800 has one monopole antenna 806 located along a left side of the card 800, three monopole antennas 807-809 located along a top of the card 800, one monopole antenna 810 located along a right side of the card 300, and the three PIFAs 811-813 located on top of a surface of the ground plane 814 on the PCB 802 and between and somewhat below the monopole antennas 806 and 810. Other configurations of the antenna array 804 are possible and may be used within the scope of the present invention.

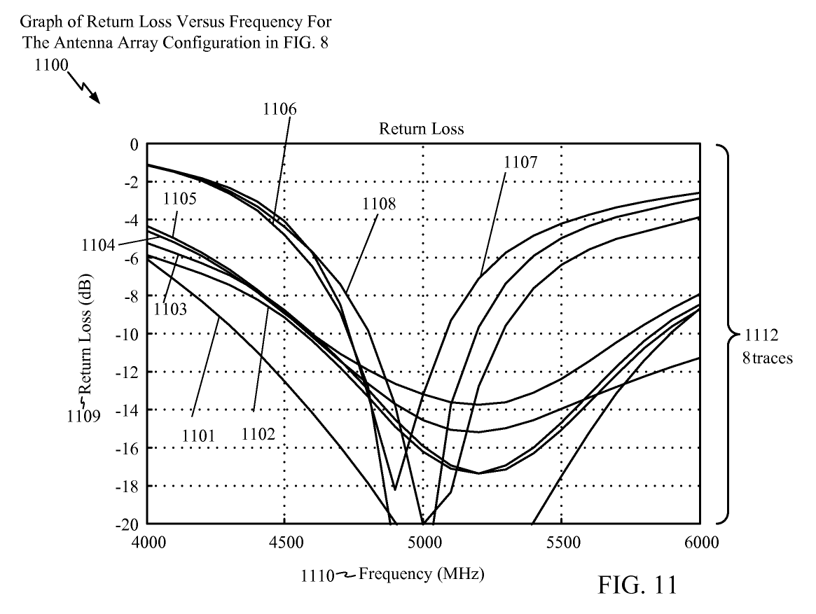

The antenna array 804, illustrated in FIGS. 8-10, advantageously permits the PCMCIA card 800, having dimensions compatible with industry standard dimensions (e.g., length and width), to be adapted for use in an 8×8 MIMO communication system 100. The antenna array 804, 8×8 for example, is small enough to fit on a distal end of the PCMCIA card 800 while provide an acceptable antenna radiation pattern, and other acceptable communications characteristics, as further described in FIGS. 11-15.

FIG. 11 illustrates an example of a graph 1100 of return loss 1109 versus frequency 1110 providing a measure of return loss for the antenna array configuration 804, as shown in FIGS. 8-10, in accordance with certain aspects of the present disclosure.

The graph 1100 represents return loss 1109 from 0 to −20 dB. The graph 1100 represents frequency range from 4000 to 6000 MHz. A process for measuring return loss 1109 versus frequency 1110 for an antenna array is well known to those skilled in the art of antenna array designs. FIG. 1100 illustrates acceptable performance for return loss 1109 versus frequency 1110 for the antenna array configuration 804.

The graph 1100 illustrates eight traces 1112, wherein each trace 1101-1108 corresponds to a return loss 1109 versus frequency 1110 for one of the antennas 806-813. In particular, traces 1101, 1102, 1103, 1104, 1105, 1106, 1107, and 1108 correspond to antennas 806 through 813, respectively.

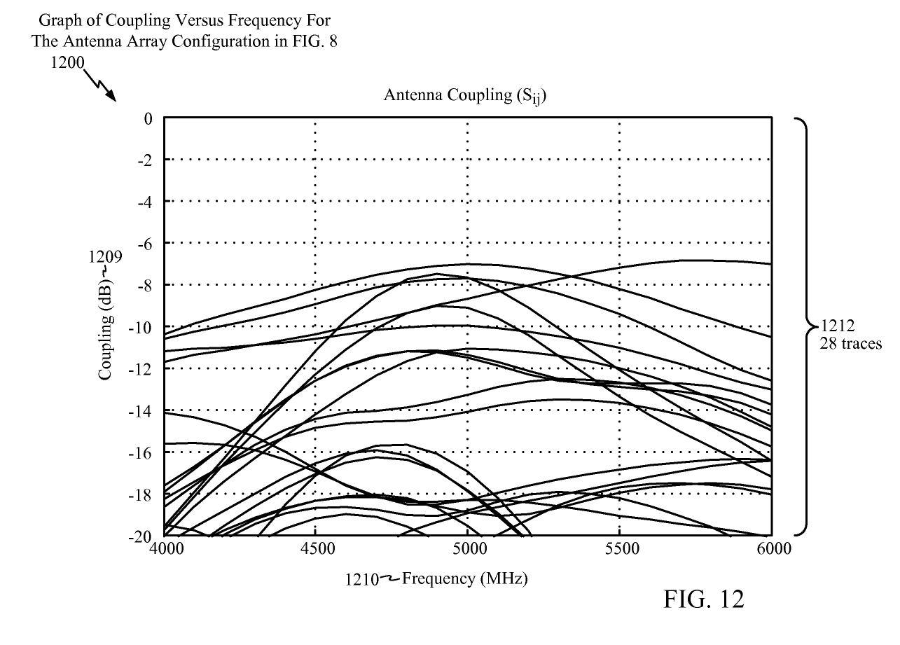

FIG. 12 illustrates an example of a graph 1200 of antenna coupling 1209 versus frequency 1210 for the antenna array configuration 804, as shown in FIG. 8, in accordance with certain aspects of the present disclosure.

The graph 1200 represents antenna coupling 1209 from 0 to −20 dB. The graph 1100 represents frequency range from 4000 to 6000 MHz. A process for measuring antenna coupling 1209 versus frequency 1210 for an antenna array is well known to those skilled in the art of antenna array designs. FIG. 1200 illustrates acceptable performance for antenna coupling 1209 versus frequency 1210 for the antenna array configuration 804.

The graph 1200 illustrates 28 traces 1212, wherein each trace corresponds to antenna coupling 1209 versus frequency 1210 among the antennas 806-813. For example, one trace represents antenna coupling 1209 versus frequency 1210 between antennas 806 and 807, another represents antenna coupling 1209 versus frequency 1210 between antennas 806 and 808, and so forth.

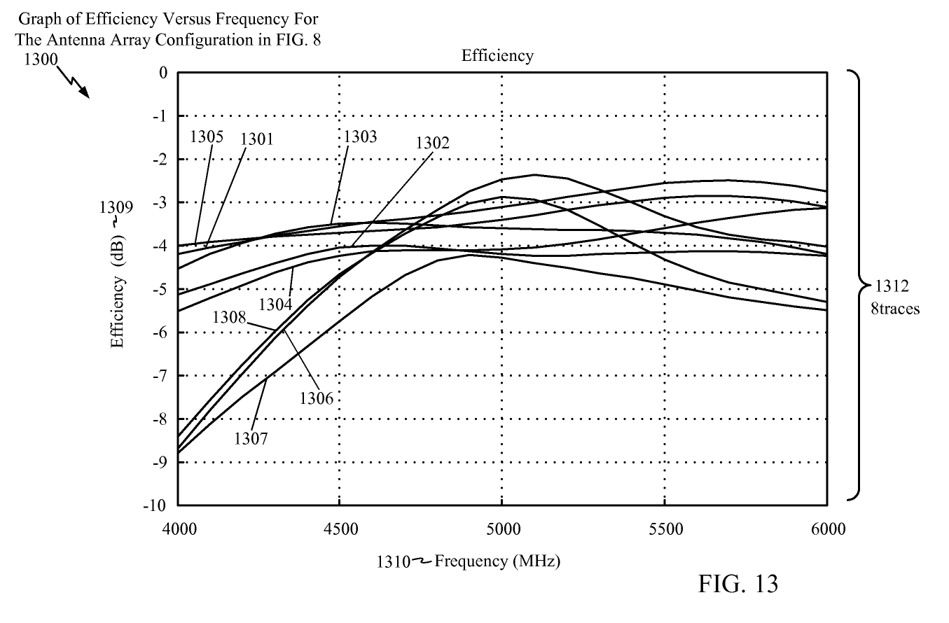

FIG. 13 illustrates an example of a graph 1300 of efficiency 1309 versus frequency 1310 for the antenna array configuration 804, as shown in FIG. 8, in accordance with certain aspects of the present disclosure.

The graph 1300 represents efficiency 1309 from 0 to −10 dB. The graph 1300 represents frequency range from 4000 to 6000 MHz. A process for measuring efficiency 1309 versus frequency 1310 for an antenna array is well known to those skilled in the art of antenna array designs. FIG. 13 illustrates acceptable performance for efficiency 1309 versus frequency 1310 for the antenna array configuration 804.

The graph 1300 illustrates eight traces 1312, wherein each trace 1301-1308 corresponds to an efficiency 1309 versus frequency 1310 for one of the antennas 806-813. In particular, traces 1301, 1302, 1303, 1304, 1305, 1306, 1307, and 1308 correspond to antennas 806 through 813, respectively.

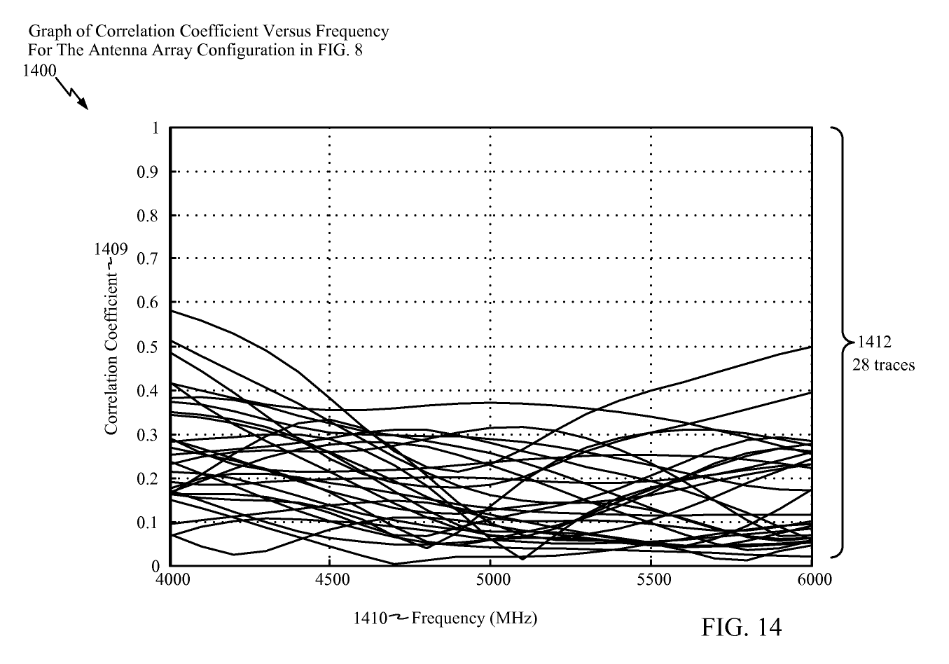

FIG. 14 illustrates an example of a graph 1400 of correlation coefficient 1409 versus frequency 1410 for the antenna array configuration 804, as shown in FIG. 8, in accordance with certain aspects of the present disclosure.

The graph 1400 represents correlation coefficients 1409 from 0 to 1. The graph 1400 represents frequency range from 4000 to 6000 MHz. A process for measuring correlation coefficients 1409 versus frequency 1410 for an antenna array is well known to those skilled in the art of antenna array designs. FIG. 14 illustrates acceptable performance for correlation coefficients 1409 versus frequency 1410 for the antenna array configuration 804.

The graph 1400 illustrates 28 traces 1412, wherein each trace corresponds to correlation coefficients 1409 versus frequency 1410 among the antennas 806-813. For example, one trace represents correlation coefficients 1409 versus frequency 1410 between antennas 806 and 807, another represents correlation coefficients 1409 versus frequency 1410 between antennas 806 and 808, and so forth.

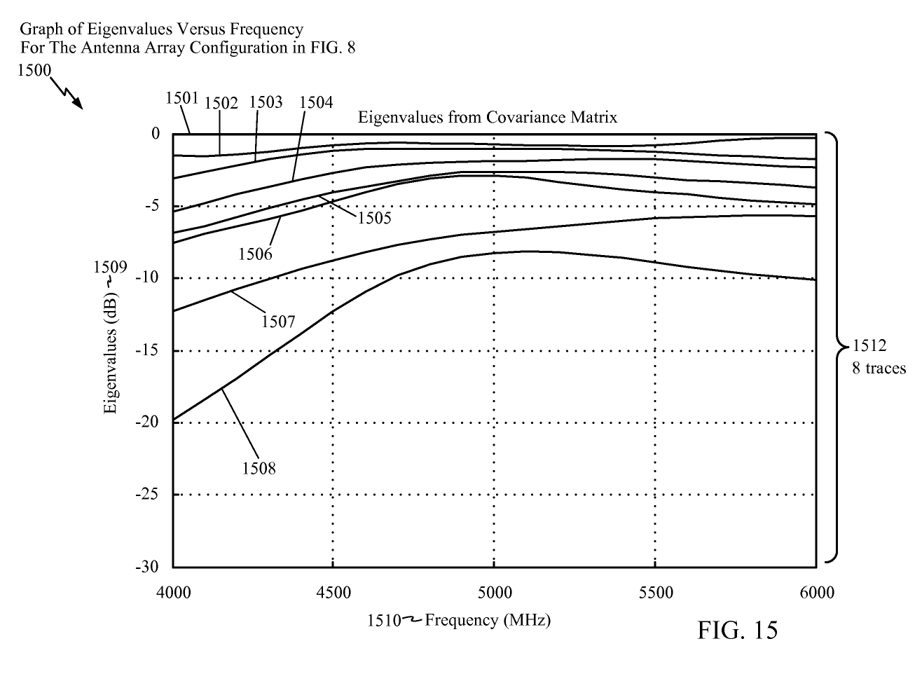

FIG. 15 illustrates an example of a graph 1500 of Eigenvalues 1509 versus frequency 1510 of the covariance matrix for the antenna array configuration 804, as shown in FIG. 8, in accordance with certain aspects of the present disclosure.

The graph 1500 represents Eigenvalues 1509 from 0 to −30 dB. The graph 1500 represents frequency range from 4000 to 6000 MHz. A process for calculating Eigenvalues 1509 of the covariance matrix from radiation patterns versus frequency 1510 for an antenna array is well known to those skilled in the art of antenna array designs. FIG. 15 illustrates acceptable performance for Eigenvalues 1509 versus frequency 1510 for the antenna array configuration 804.

The graph 1500 illustrates eight traces 1512, wherein each trace corresponds to Eigenvalues 1509 versus frequency 1510 among the antennas 806-813. The first trace 1501 is normalized to 0 dB. In particular, traces 1501, 1502, 1503, 1504, 1505, 1506, 1507, and 1508 are sorted according to their magnitude.

3. PCMCIA Card Having a PCB with Five Monopole and Three Donut Antennas.

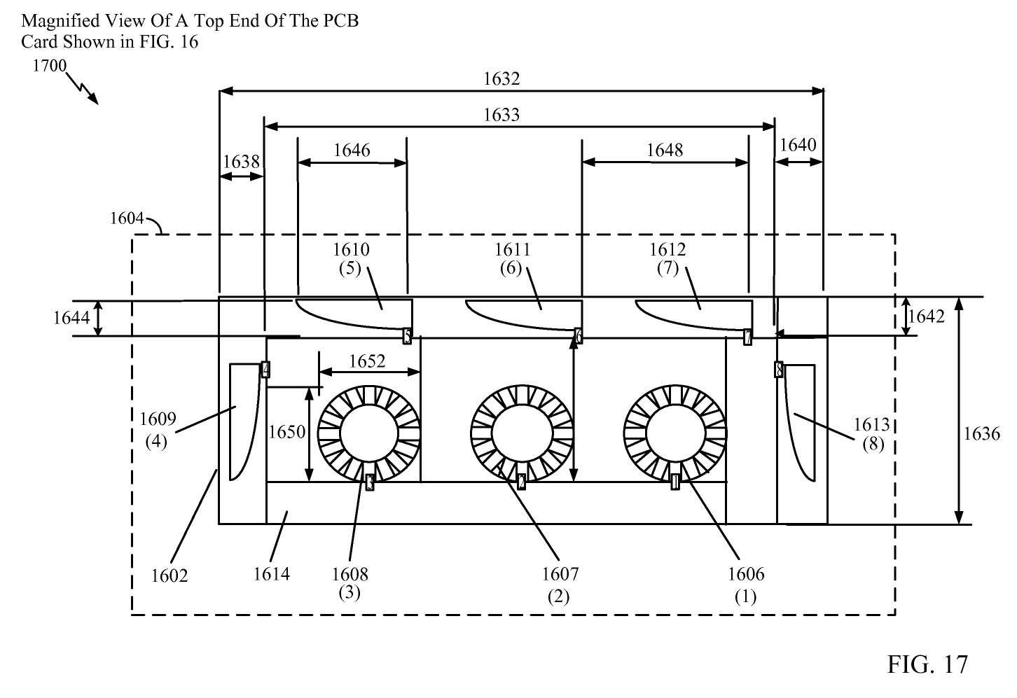

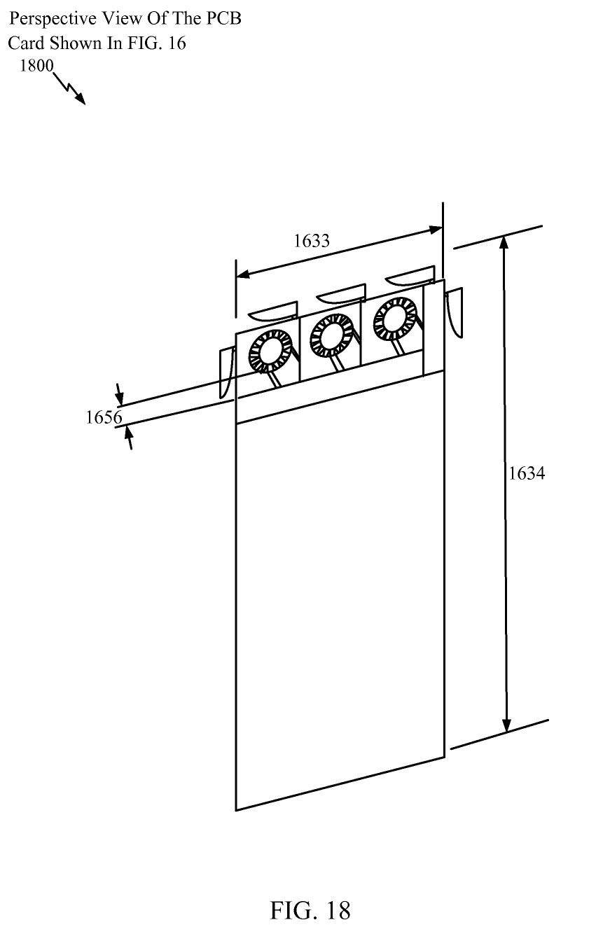

FIG. 16 illustrates an example of a simulated PCMCIA card 1600 employing an antenna array configuration 1604 having five (5) printed monopole antennas 1609-1613 and three (3) donut antennas 1606-1608 for use with the system 100, as shown in FIGS. 1 and 2, in accordance with certain aspects of the present disclosure. FIG. 17 illustrates an example of a magnified view 1700 of a top end of the PCMCIA card 1600, as shown in FIG. 16, in accordance with certain aspects of the present disclosure. FIG. 18 illustrates an example of a top, right, and rear perspective view of the PCMCIA card 1600, as shown in FIG. 16, in accordance with certain aspects of the present disclosure. The PCMCIA card 1600 may be of the type that connects to other electronic devices, such as a laptop computer, to provide the electronic device with radio frequency (RF) wireless communication capability.

The PCMCIA card 1600 generally includes a printed circuit board 1602, a ground plane 1614, and five (5) printed monopole antennas 1609-1613 (also labeled 4-8, respectively) and three donut antennas 1606-1608 (also labeled 1-3, respectively), wherein all eight antennas together form the antenna array 1604. Not shown, but electrically simulated, in FIGS. 16-18 are eight (8) electrically conductive. Each printed monopole antenna is of the type described with reference to FIGS. 3 and 4 hereinabove.

The PCB 1602 may have a width dimension 1632 of 58 mm and a length dimension 1634 of 114 mm. The ground plane 1614 may have a width dimension 1633 of 50 mm and a length dimension 1658 of 110 mm. The ground plane 1614 may be centered within a distal end surface of the PCB 1602 permitting a non-grounded border portion of the PCB to have a left border dimension 1638 of 4 mm, a top border dimension 1642 of 4 mm, and a right border dimension 1640 of 4 mm. The antenna array 1604, located at the distal end of the PCB 1602 has a length dimension 1636 of about 20 mm. In FIG. 4, each monopole antenna 1609-1613 has a width dimension 1644 of 3.2 mm and a length dimension 1646 of 11.2 mm. In FIG. 4, a separation distance 1648 between each monopole antenna 1609-1613 is about 16 mm, corresponding to approximately ¼ wavelength. The donut antennas are located a height dimension 1656 of 5 mm above the ground plane 1614. Each of the donut antennas has a length dimension 1652 of 10 mm and a width dimension 1650 of 10 mm. Adjacent donut antennas may be separated by a separation distance 851 of 15 mm. Other dimensions or features, such as these described as well as other features, shown in FIGS. 16-18, may be permitted within the scope of the present invention.

Donut antennas are similar to planar inverted F antenna (PIFA) with a feed point and a shorting post connection to ground. Donut antennas may have more bandwidth and better efficiency than chip or monopole antennas.

Individually, various design and engineering details for prototype and production versions of each of the printed circuit board 1602 (e.g. FR4), the ground plane 1614, the five printed monopole antennas 1609-1613, the three donut antennas 1606-1608, the eight electrically conductive paths (not shown, but simulated), are well known to those skilled in the art of those individual elements.

The PCMCIA card 1600 has one monopole antenna 1609 located along a left side of the card 1600, three monopole antennas 1610-1612 located along a top of the card 1600, one monopole antenna 1613 located along a right side of the card 1600, and the three donut antennas 1606-1608 located above a top of a surface of the ground plane 1614 on the PCB 1602 and between and somewhat below the monopole antennas 1609 and 1613. Other configurations of the antenna array 1604 are possible and may be used within the scope of the present invention.

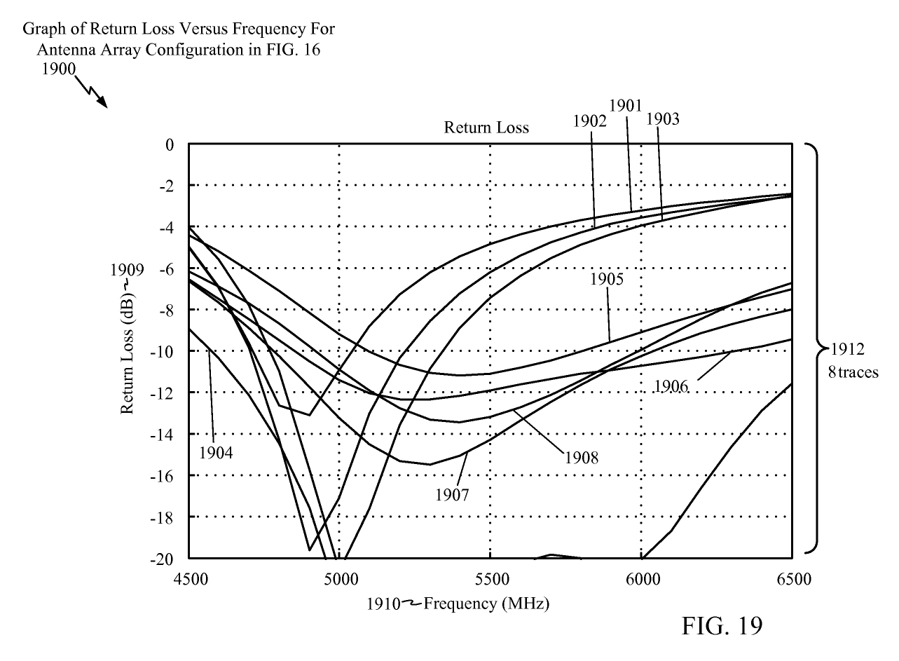

The antenna array 1604, illustrated in FIGS. 16-18, advantageously permits the PCMCIA card 1600, having dimensions compatible with industry standard dimensions (e.g., length and width), to be adapted for use in an 8×8 MIMO communication system 100. The antenna array 804, 8×8 for example, is small enough to fit on a distal end of the PCMCIA card 1600 while provide an acceptable antenna radiation pattern, and other acceptable communications characteristics, as further described in FIGS. 19-23.

FIG. 19 illustrates an example of a graph 1900 of return loss 1909 versus frequency 1910 for the antenna array configuration 1604, as shown in FIG. 16, in accordance with certain aspects of the present disclosure.

The graph 1900 represents return loss 1909 from 0 to −20 dB. The graph 1900 represents frequency range from 4500 to 6500 MHz. A process for measuring return loss 1909 versus frequency 1910 for an antenna array is well known to those skilled in the art of antenna array designs. FIG. 1900 illustrates acceptable performance for return loss 1909 versus frequency 1910 for the antenna array configuration 1604.

The graph 1900 illustrates eight traces 1112, wherein each trace 1901-1908 corresponds to return loss 1909 versus frequency 1910 for one the antennas 1606-1613. In particular, traces 1901, 1902, 1903, 1904, 1905, 1906, 1907, and 1908 correspond to antennas 1606 through 1613, respectively.

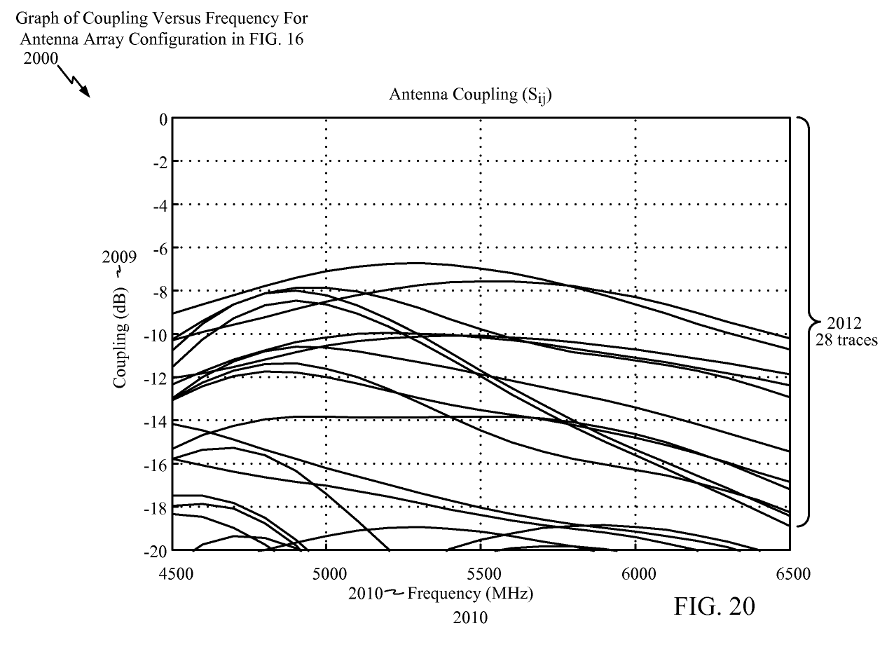

FIG. 20 illustrates an example of a graph 2000 of antenna coupling 2009 versus frequency 2010 for the antenna array configuration 1604, as shown in FIG. 16, in accordance with certain aspects of the present disclosure.

The graph 2000 represents antenna coupling 2009 from 0 to −20 dB. The graph 2000 represents frequency range from 4500 to 6500 MHz. A process for measuring antenna coupling 2009 versus frequency 2010 for an antenna array is well known to those skilled in the art of antenna array designs. FIG. 2000 illustrates acceptable performance for antenna coupling 2009 versus frequency 2010 for the antenna array configuration 1604.

The graph 2000 illustrates 28 traces 2012, wherein each trace corresponds to antenna coupling 2009 versus frequency 2010 among the antennas 1606-1613. For example, one trace represents antenna coupling 2009 versus frequency 2010 between antennas 1606 and 1607, another represents antenna coupling 2009 versus frequency 2010 between antennas 1606 and 1608, and so forth. Some of the coupling traces are less than or equal to 20 dB and not to scale in the graph.

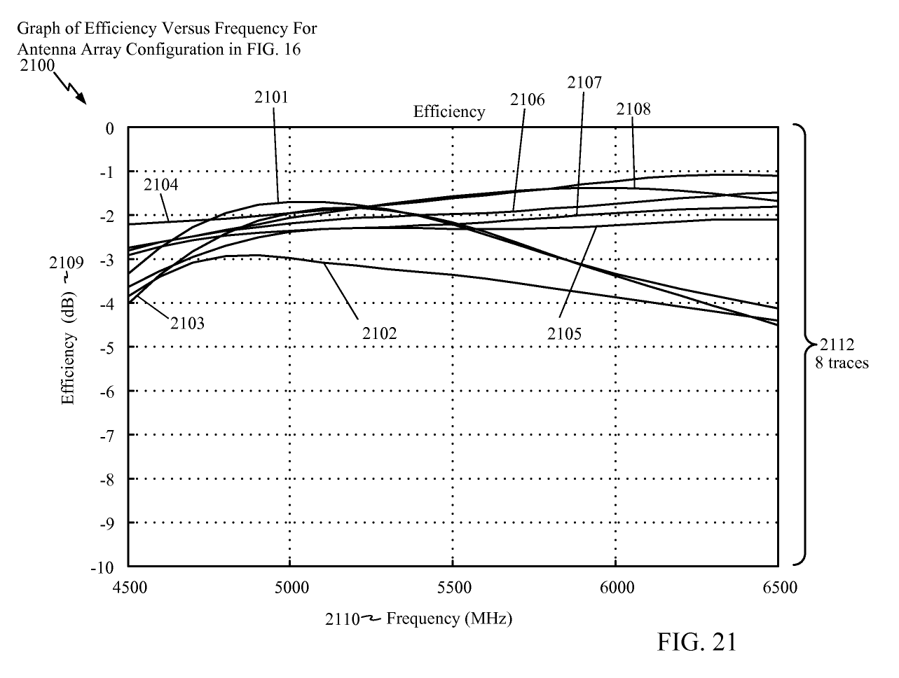

FIG. 21 illustrates an example of a graph 2100 of efficiency, in terms of efficiency, 2109 versus frequency 2110 for the antenna array configuration 1604, as shown in FIG. 16, in accordance with certain aspects of the present disclosure.

The graph 2100 represents efficiency 2109 from 0 to −10 dB. The graph 2100 represents frequency range from 4500 to 6500 MHz. A process for measuring efficiency 2109 versus frequency 2110 for an antenna array is well known to those skilled in the art of antenna array designs. FIG. 21 illustrates acceptable performance for efficiency 2109 versus frequency 2110 for the antenna array configuration 1604.

The graph 2100 illustrates eight traces 2112, wherein each trace 2101-2108 corresponds to an efficiency 2109 versus frequency 2110 for one of the antennas 1606-1613. In particular, traces 2101, 2102, 2103, 2104, 2105, 2106, 2107, and 2108 correspond to antennas 1606 through 1613, respectively.

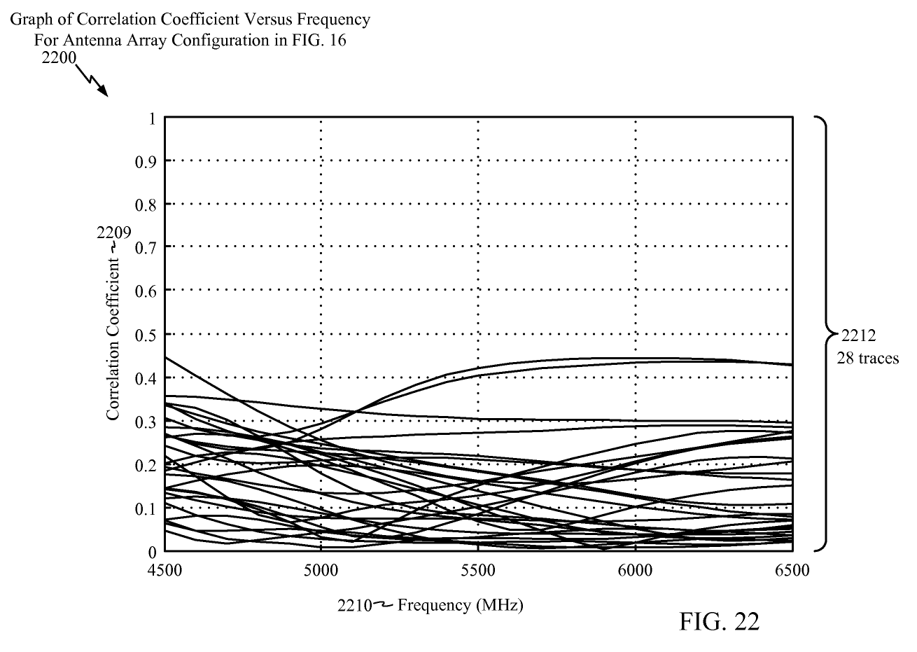

FIG. 22 illustrates an example of a graph 2200 of correlation coefficient 2209 versus frequency 2210 for the antenna array configuration 1604, as shown in FIG. 16, in accordance with certain aspects of the present disclosure.

The graph 1600 represents correlation coefficients 1609 from 0 to 1. The graph 1600 represents frequency range from 4500 to 6500 MHz. A process for measuring correlation coefficients 1609 versus frequency 1610 for an antenna array is well known to those skilled in the art of antenna array designs. FIG. 22 illustrates acceptable performance for correlation coefficients 1609 versus frequency 1610 for the antenna array configuration 1604.

The graph 2100 illustrates 8 traces 2112, wherein each trace corresponds to correlation coefficients 2109 versus frequency 2110 among the antennas 1606-1613. For example, one trace represents correlation coefficients 2109 versus frequency 2110 between antennas 1606 and 1607, another represents correlation coefficients 2109 versus frequency 2110 between antennas 1606 and 1808, and so forth.

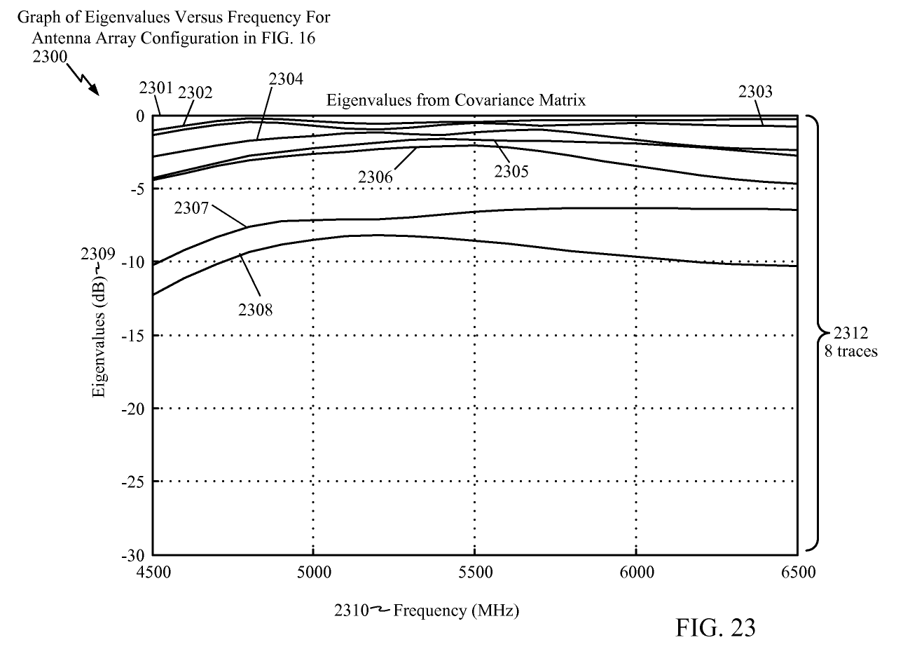

FIG. 23 illustrates an example of a graph 2300 of Eigenvalues 2309 versus frequency 2310 of the covariance matrix for the antenna array configuration 1604, as shown in FIG. 16, in accordance with certain aspects of the present disclosure.

The graph 2300 represents Eigenvalues 2309 from 0 to −30 dB. The graph 2300 represents frequency range from 4500 to 6500 MHz. A process for calculating Eigenvalues 2309 versus frequency 2310 from radiation patterns for an antenna array is well known to those skilled in the art of antenna array designs. FIG. 23 illustrates acceptable performance for Eigenvalues 2309 versus frequency 2310 for the antenna array configuration 1604.

The graph 2300 illustrates eight traces 2312, wherein each trace corresponds to Eigenvalues 2309 versus frequency 2310 among the antennas 1606-1613. The first trace 1601 is normalized to 0 dB. In particular, traces 2301, 2302, 2303, 2304, 2305, 2306, 2307, and 2308 are sorted according to their magnitude.

4. PCMCIA Card Having a PCB with Six Chip Antennas and Two PIFAs.

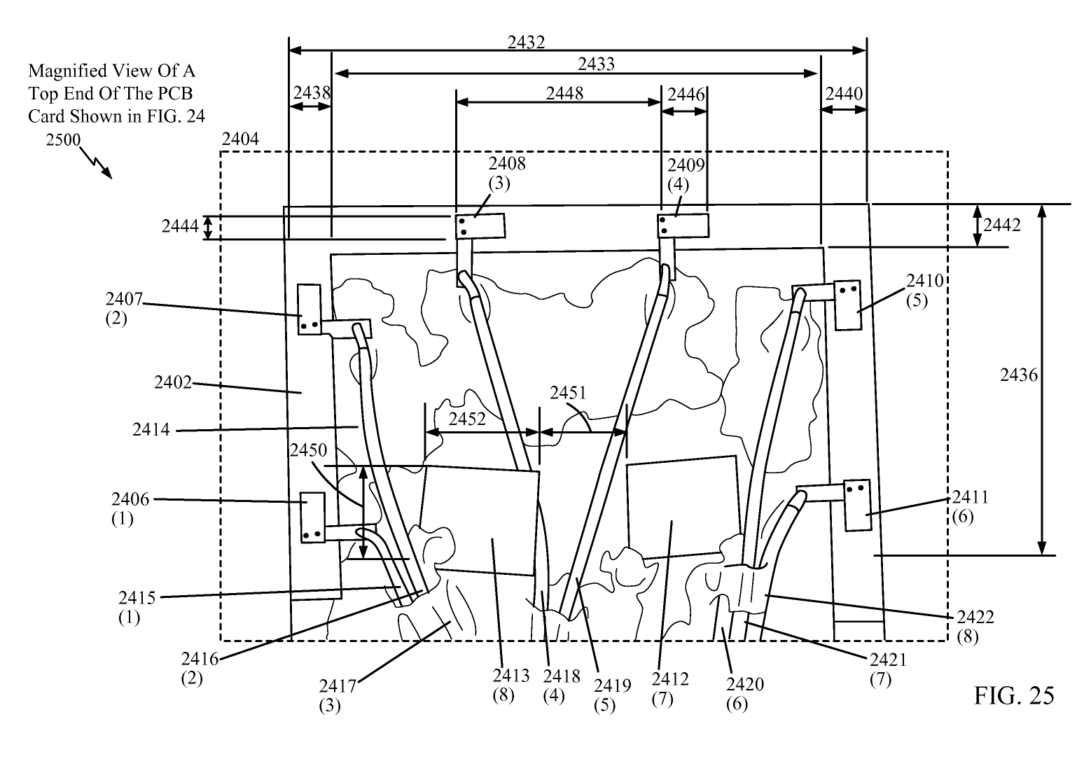

FIG. 24 illustrates an example of a prototype PCMCIA card 2400 employing an antenna array configuration 2404 having six (6) ceramic chip antennas 2406-2411 and two (2) planar inverted F antennas (PIFA) 2412-2413 for use with the system 100, as shown in FIGS. 1 and 2, in accordance with certain aspects of the present disclosure. FIG. 25 illustrates an example of a magnified view 2500 of a top end of the PCMCIA card 2400, as shown in FIG. 24, in accordance with certain aspects of the present disclosure. The PCMCIA card 2400 may be of the type that connects to other electronic devices, such as a laptop computer, to provide the electronic device with radio frequency (RF) wireless communication capability.

The PCMCIA card 2400 generally includes a printed circuit board 2402, a ground plane 2414, six (6) ceramic chip antennas 2406-2411 (also labeled 1-6, respectively) and two (2) planar inverted F antennas (PIFA) 2412-2413 (also labeled 7-8, respectively), wherein all eight antennas together form the antenna array 2404. Also illustrated in FIGS. 24-25 are eight (8) electrically conductive paths 2415-2422 and eight (8) eight connectors 2423-2430.

The PCB 2402 may have a width dimension 2432 of 50 mm and a length dimension 2434 of 125 mm. The ground plane 2414 may have a width dimension 2433 of 50 mm and a length dimension 2458 of 121 mm. The ground plane 2414 may be centered within a distal end surface of the PCB 2402 permitting a non-grounded border portion of the PCB to have a left border dimension 2438 of 4 mm, a top border dimension 2442 of 4 mm, and a right border dimension 2440 of 4 mm. The antenna array 2404, located at the distal end of the PCB 2402 has a length dimension 2436 of about 30 mm. In FIG. 24, each ceramic chip antenna 2406-2411 has a width dimension 2444 of 2 mm, a length dimension 2446 of 4 mm, and a height dimension of 0.8 mm. In FIG. 4, a separation distance 2448 between each ceramic antenna 2406-2411 is about 15 mm, corresponding to approximately ¼ wavelength. The two PIFAs 2412-2413 are located a height dimension of 4 mm above the ground plane 2414. Each of the PIFAs 2412-2413 has a length dimension 2452 of 9 mm and a width dimension 2450 of 9 mm. Adjacent PIFAs may be separated by a separation distance 2451 of 15 mm. Other dimensions or features, such as these described as well as other features, shown in FIGS. 24-25, may be permitted within the scope of the present invention.

Ceramic chip antennas may be formed in a variety of ways and may have a variety of shapes, which are primarily rectangular. Ceramic chip antennas advantageously provide a small surface area for mounting on a PCB and recently have been improved to provide wider bandwidth and higher efficiency. Examples of ceramic chip antennas that may be used with the present invention include those made by Taiyo Yuden Co., Ltd., including, for example, part number AH 316M245001 (3.2 L×1.6 W×0.5 mm T), 2.4 GHz chip antenna, made for use in Bluetooth® and wireless LAN applications in mobile phones and other mobile devices. Examples of antenna structures employed within a ceramic chip package include monopole and wire inverted F antenna (WIFA). For example, WIFAs are shown in FIGS. 24, 25, 31, and 32. Other ceramic chip antennas from other manufacturers, in various sizes, having various frequency ranges, and having various performance characteristics may also be used within the scope of the present invention.

Individually, various design and engineering details for prototype and production versions of each of the printed circuit board 2402 (e.g. FR4), the ground plane 2414, the six (6) ceramic chip antennas 2406-2411, the two (2) planar inverted F antennas (PIFA) 2412-2413, the eight electrically conductive paths 2415-2422, and eight (8) eight connectors 2423-2430, are well known to those skilled in the art of those individual elements.

The PCMCIA card 2400 has two chip antennas 2406-2407 located along a left side of the card 2400, two chip antennas 2408-2409 located along a top of the card 2400, two chip antennas 2410-2411 located along a right side of the card 2400, and the two PIFAs 2412-2413 located above top of a surface of the ground plane 2414 on the PCB 2402, and between and somewhat below the chip antennas 2406 and 2411. Other configurations of the antenna array 2404 are possible and may be used within the scope of the present invention.

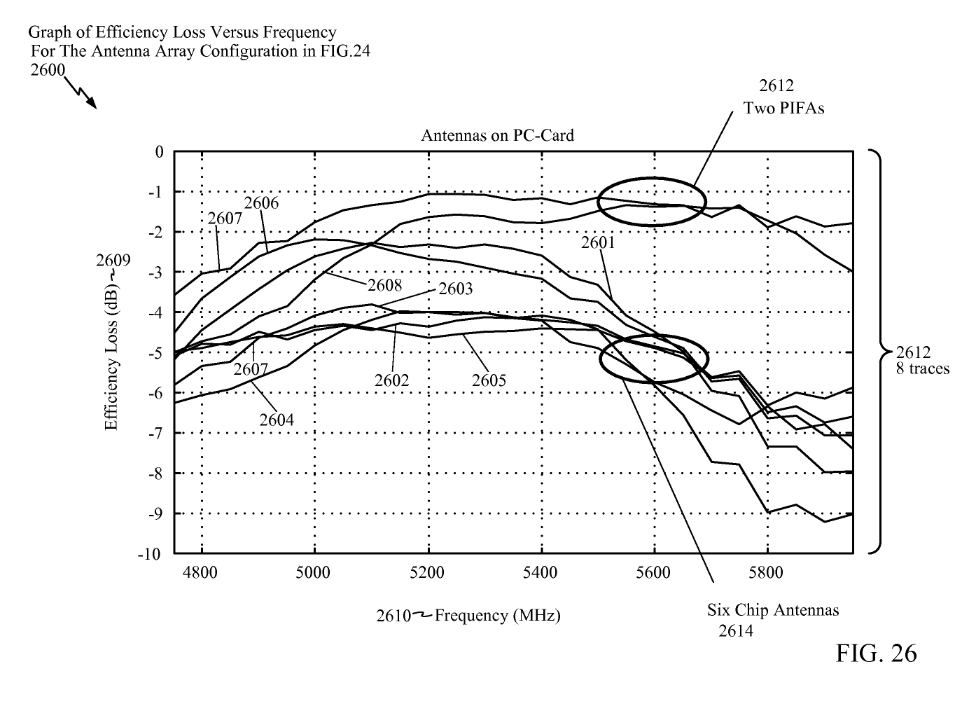

The antenna array 2404, illustrated in FIGS. 24-25, advantageously permits the PCMCIA card 2400, having dimensions compatible with industry standard dimensions (e.g., length and width), to be adapted for use in an 8×8 MIMO communication system 100. The antenna array 2404, 8×8 for example, is small enough to fit on a distal end of the PCMCIA card 2400 while provide an acceptable antenna radiation pattern, and other acceptable communications characteristics, as further described in FIGS. 26-30.

FIG. 26 illustrates an example of a graph 2600 of efficiency loss 2609 versus frequency 2610 for the antenna array configuration 2404, as shown in FIG. 24, in accordance with certain aspects of the present disclosure.

The graph 2600 represents efficiency loss 2609 from 0 to −10 dB. The graph 2600 represents frequency range from 4700 to 6000 MHz. A process for measuring efficiency loss 2609 versus frequency 2610 for an antenna array is well known to those skilled in the art of antenna array designs. FIG. 26 illustrates acceptable performance for efficiency loss 2609 versus frequency 2610 for the antenna array configuration 2404.

The graph 2600 illustrates eight traces 2612, wherein each trace 2601-2608 corresponds to an efficiency loss 2609 versus frequency 2610 for one the antennas 2406-2413. In particular, traces 2601, 2602, 2603, 2604, 2605, 2606, 2607, and 2608 correspond to antennas 2406 through 2413, respectively.

The data illustrated in the graph 2600 includes electrical loss of about 0.2 to 0.3 dB in each of the paths 2415-2422, which are constructed as coaxial cables in the prototype version of the PCMCIA card 2400. Such electrical loss may not be present in production version of the PCMCIA card 2400, wherein PCB traces on the PCB 2402 are used to provide the paths 2415-2422. Therefore, the efficiency loss 2609 for each antenna 2406-2413 versus frequency 2610 may improve in the graph 2600 by about 0.2 to 0.3 dB in a production version of the PCMCIA card 2600.

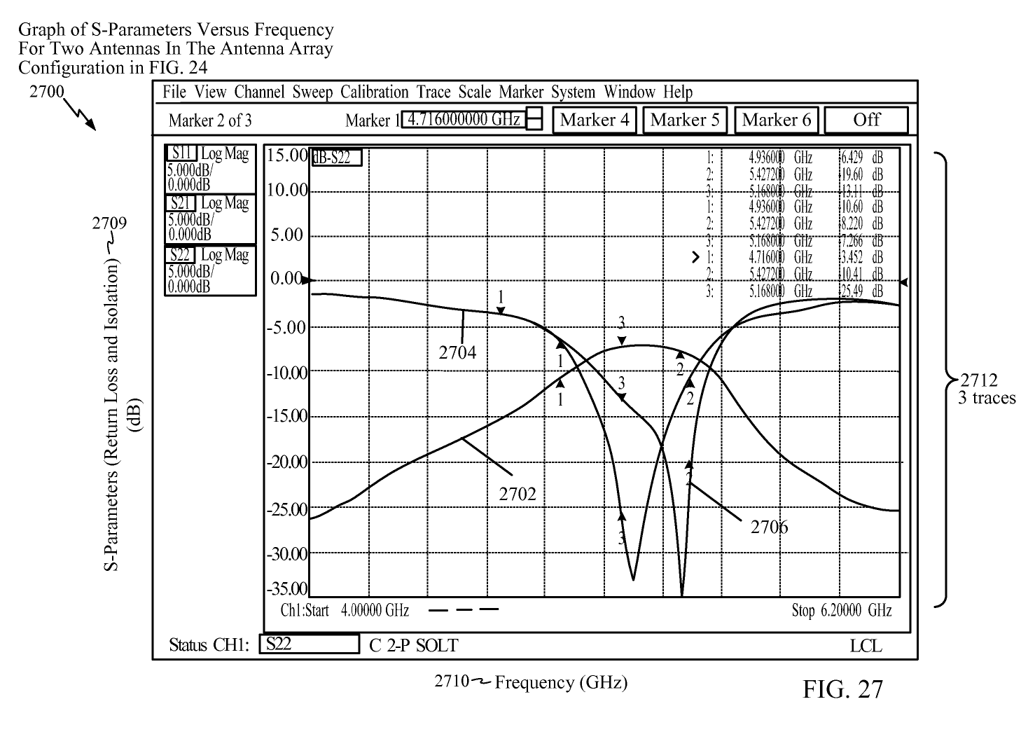

FIG. 27 illustrates an example of a graph 2700 of S-parameters (e.g., return loss and isolation) 2709 versus frequency 2710 for two adjacent antennas in the antenna array configuration 2404, as shown in FIG. 24, in accordance with certain aspects of the present disclosure.

The graph 2700 represents the S-parameters 2709 from 0 to −35 dB. The graph 2700 represents frequency range from 4000 to 6200 MHz. A process for measuring S-parameters 2709 versus frequency 2710 for an antenna array is well known to those skilled in the art of antenna array designs. FIG. 2700 illustrates acceptable performance for S-parameters 2709 versus frequency 2710 for the antenna array configuration 2404.

The graph 2700 illustrates three traces 2712, wherein each trace 2704, 2706, and 2708 corresponds to S-parameters 2709 versus frequency 2710 for two adjacent antennas 2406-2408. In particular, traces 2704 and 2706 correspond to return loss 2709 versus frequency 2710 for the two adjacent antennas 2407 and 2408 (i.e., around the corner of the PCB), respectively. Trace 2702 represents isolation 2709 versus frequency 2710 between the two adjacent antennas 2407 and 2408. As shown in FIG. 27, antennas 2407 and 2408 provide the worst isolation.

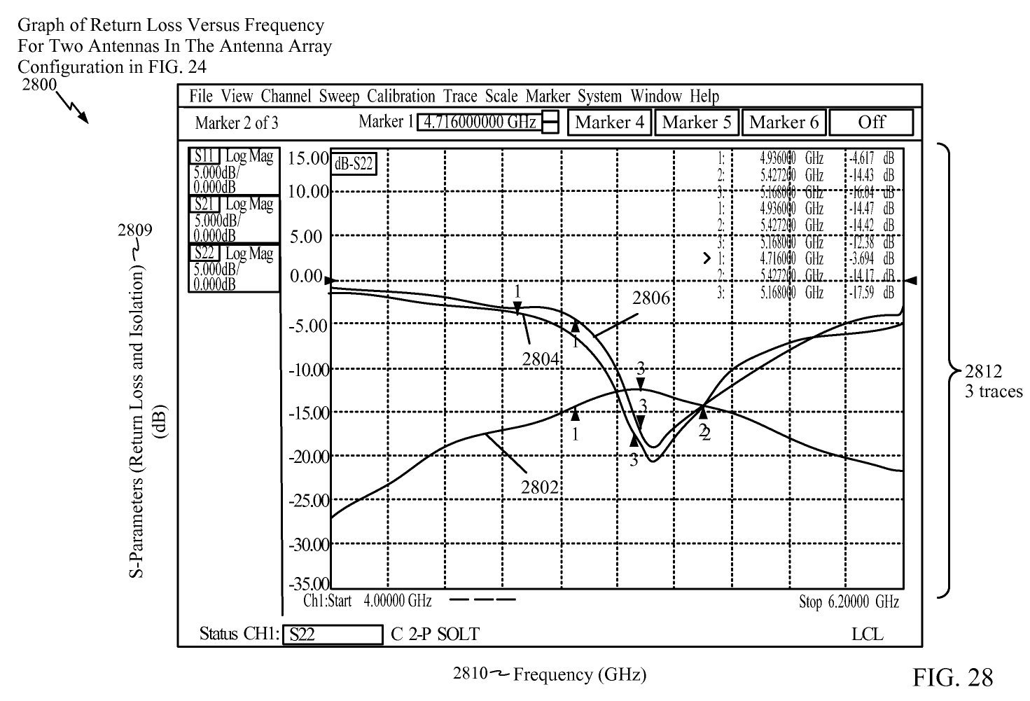

FIG. 28 illustrates an example of a graph 2800 of S parameters 2809 versus frequency 2810 providing a measure of return loss and isolation for the antenna array configuration 2404, as shown in FIG. 24, in accordance with certain aspects of the present disclosure.

The graph 2800 represents S parameters 2809 from 0 to −35 dB. The graph 2800 represents frequency range from 4000 to 6200 MHz. A process for measuring S parameters 2809 versus frequency 2810 for an antenna array 2800 is well known to those skilled in the art of antenna array designs. FIG. 2800 illustrates acceptable performance for S parameters 2809 versus frequency 2810 for the antenna array configuration 2404.

The graph 2800 illustrates three traces 2812, wherein each trace 2802, 2804, and 2806 corresponds to S parameters 2809 versus frequency 2810 for two adjacent antennas 2412 and 2413. In particular, traces 2804 and 2806 correspond to return loss 2809 versus frequency 2810 for the two adjacent antennas 2412 and 2413, respectively. Trace 2802 represents isolation 2809 versus frequency 2810 between the two adjacent antennas 2412 and 2413. As shown in FIG. 28, PIFAs 2412 and 2413 provide the largest return loss bandwidth.

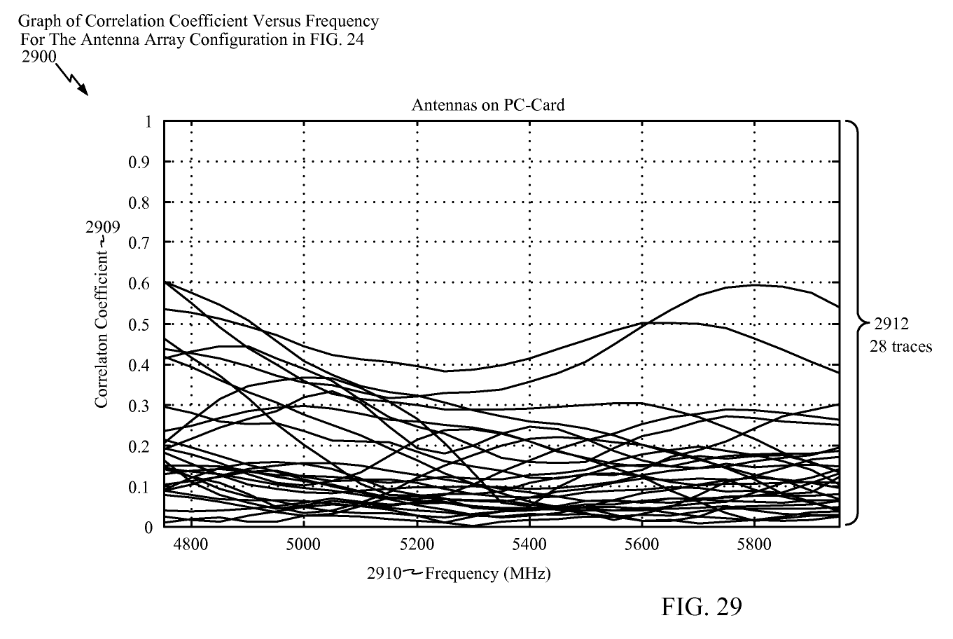

FIG. 29 illustrates an example of a graph 2900 of correlation coefficient 2909 versus frequency 2910 for the antenna array configuration 2404, as shown in FIG. 24, in accordance with certain aspects of the present disclosure.

The graph 2900 represents correlation coefficients 2909 from 0 to 1. The graph 2900 represents frequency range from 4700 to 6000 MHz. A process for measuring correlation coefficients 2909 versus frequency 2910 for an antenna array is well known to those skilled in the art of antenna array designs. FIG. 29 illustrates acceptable performance for correlation coefficients 2909 versus frequency 2910 for the antenna array configuration 2404.

The graph 2900 illustrates 28 traces 2912, wherein each trace corresponds to correlation coefficients 2909 versus frequency 2910 among the antennas 2406-2413. For example, one trace represents correlation coefficients 2909 versus frequency 2910 between antennas 2406 and 2407, another represents correlation coefficients 2909 versus frequency 2910 between antennas 2406 and 2408, and so forth.

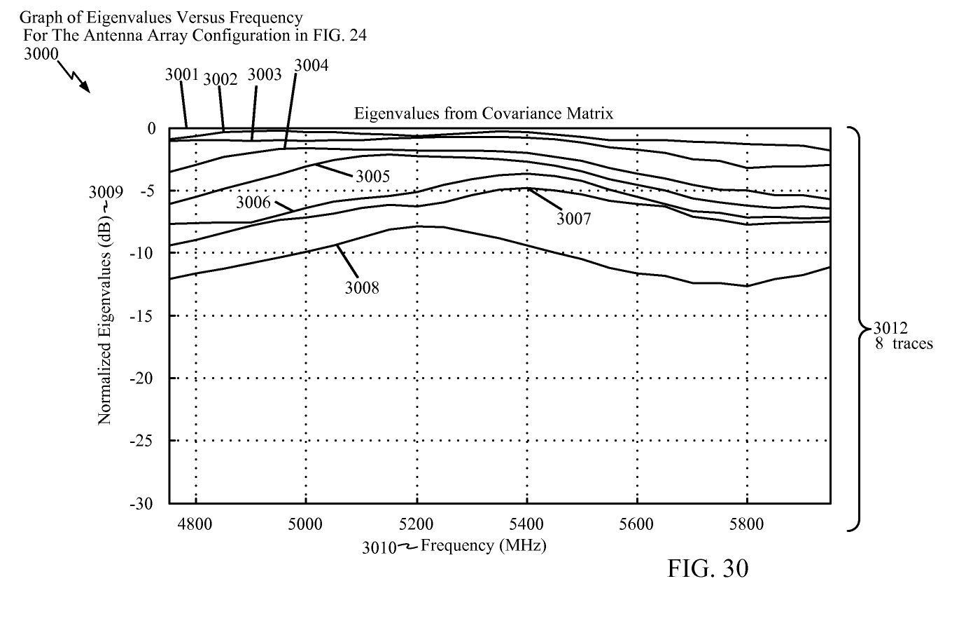

FIG. 30 illustrates an example of a graph 3000 of Eigenvalues 3009 of the covariance matrix versus frequency 3010 for the antenna array configuration 2404, as shown in FIG. 24, in accordance with certain aspects of the present disclosure.

The graph 3000 represents Eigenvalues 3009 from 0 to −30 dB. The graph 3000 represents frequency range from 4700 to 5800 MHz. A process for calculating Eigenvalues 3009 versus frequency 3010 from radiation patterns for an antenna array is well known to those skilled in the art of antenna array designs. FIG. 30 illustrates acceptable performance for Eigenvalues 3009 versus frequency 3010 for the antenna array configuration 2404.

The graph 3000 illustrates eight traces 3012, wherein each trace corresponds to Eigenvalues 3009 versus frequency 3010 among the antennas 2406-2413. The first trace 3001 is normalized to 0 dB. In particular, traces 3001, 3002, 3003, 3004, 3005, 3006, 3007, and 3008 are sorted according to their magnitude.

5. Laptop Having a PCB with Sixteen Chip Antennas.

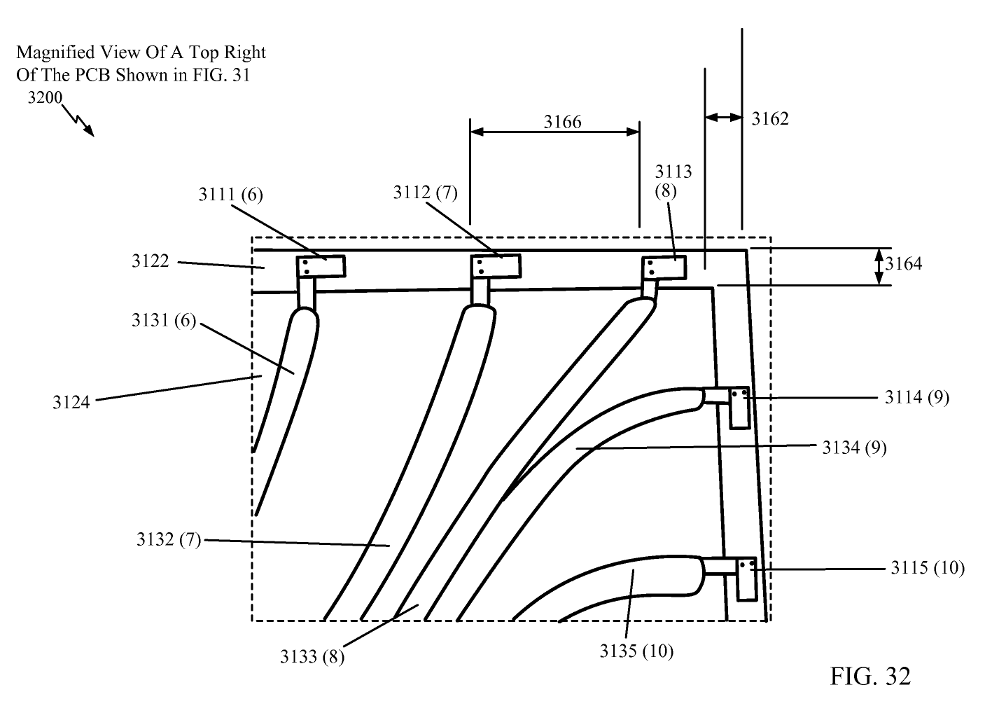

FIG. 31 illustrates an example of a laptop 3100 employing a printed circuit board (PCB) 3122 employing sixteen (16) ceramic chip antennas 3106-3121 for use with the system 100, as shown in FIGS. 1 and 2, in accordance with certain aspects of the present disclosure. FIG. 32 illustrates a magnified view 3200 of top right corner of the example shown in FIG. 31, in accordance with certain aspects of the present disclosure. The laptop 3100 may be of the type having two housings hinged together, wherein the first housing carries a display and the PCB 3122, and the second housing 3101 carries elements of a computer including the keyboard. The sixteen (16) ceramic chip antennas 3106-3121 are advantageously carried by the first housing to provide for quality communications when the first housing is in an open position (e.g., greater than 90 degrees) relative to the second housing.

The laptop 3100 generally includes a printed circuit board 3122, a ground plane 3124, and sixteen (16) ceramic chip antennas 3106-3121 (also labeled 1-16, respectively) forming an antenna array 3104. Also illustrated in FIG. 31 are sixteen (16) electrically conductive paths 3126-3131 and sixteen (16) connectors 3136-3151.

The PCB 3122 may have a width dimension 3132 of 254 mm and a length dimension 3134 of 250 mm. The ground plane 3124 may have a width dimension 3133 of 222 mm and a length dimension 3158 of 186 mm. The ground plane 3124 may be centered within a distal end surface of the PCB 3122 permitting a non-grounded border portion of the PCB to have a left border dimension 3160 of 4 mm, a top border dimension 3164 of 4 mm, and a right border dimension 3162 of 4 mm. In FIGS. 31 and 32, each ceramic chip antenna 3106-3121 has a width dimension of 2 mm, a length dimension of 4 mm, and a height dimension of 0.8 mm. In FIG. 32, a separation distance 3148 between each ceramic antenna 3106-3121 is about 15 mm, corresponding to one quarter wavelength. Other dimensions or features, such as these described as well as other features, shown in FIGS. 31 and 32, may be permitted within the scope of the present invention. The ceramic chip antennas may be the same or similar to those described with reference to FIGS. 24-25.

Individually, various design and engineering details for prototype and production versions of each of the printed circuit board 3122 (e.g. FR4), the ground plane 3124, the sixteen (16) ceramic chip antennas 3106-3121, the sixteen (16) electrically conductive paths 3126-3131 and sixteen (16) connectors 3136-3151, are well known to those skilled in the art of those individual elements.

The laptop 3100 has eight chip antennas 3106-3113 located along a top side and near a top right corner of the PCB 3122, and eight chip antennas 3114-3121 located along a right side and near a top right corner of the PCB 3122. Other configurations of the antenna array 3104 are possible and may be used within the scope of the present invention.

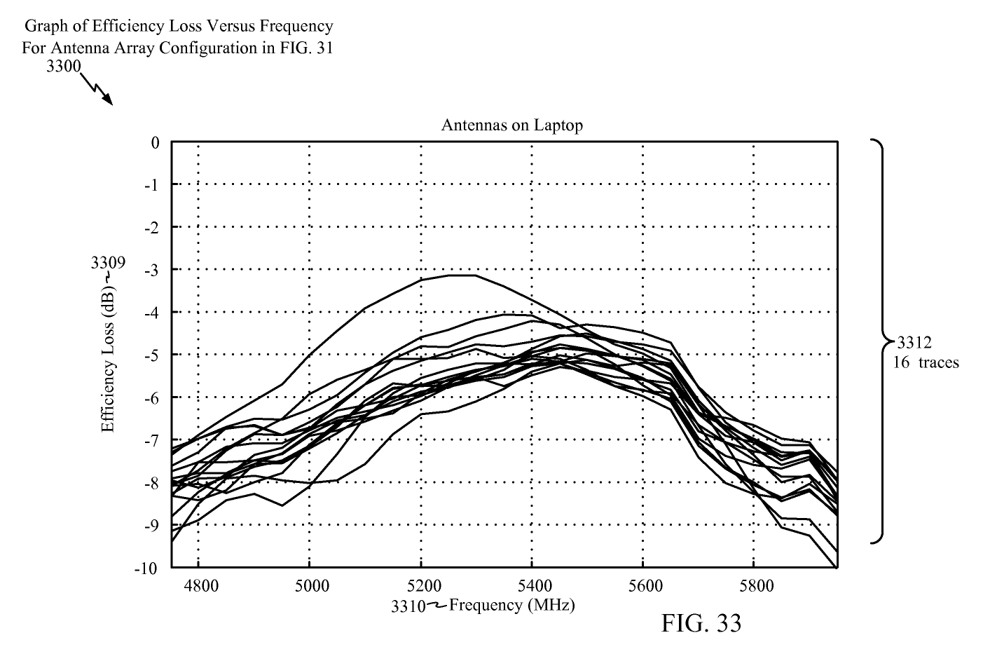

The antenna array 3104, illustrated in FIGS. 31 and 32, advantageously permits the laptop 3100, having dimensions compatible with industry standard or manufactured dimensions (e.g., length and width), to be adapted for use in a 16×16 MIMO communication system 100. The antenna array 3104, 16×16 for example, is small enough to fit at top right corner of the PCB 3122 while provide an acceptable antenna radiation pattern, and other acceptable communications characteristics, as further described in FIGS. 33-41.

FIG. 33 illustrates an example of a graph 3300 of efficiency loss 3309 versus frequency 3310 for the antenna array configuration, as shown in FIG. 31, in accordance with certain aspects of the present disclosure.

The graph 3300 represents efficiency loss 3309 from 0 to −10 dB. The graph 3300 represents frequency range from 4700 to 6000 MHz. A process for measuring efficiency loss 3309 versus frequency 3310 for an antenna array is well known to those skilled in the art of antenna array designs. FIG. 33 illustrates acceptable performance for efficiency loss 3309 versus frequency 3310 for the antenna array configuration 3104.

The graph 3300 illustrates sixteen traces 3312, wherein each trace (not numbered) corresponds to an efficiency loss 3309 versus frequency 3310 for one of the antennas 3106-3121.

The data illustrated in the graph 3300 includes electrical loss of about 1.3 dB in each of the paths 3126-3131, which are constructed as coaxial cables in the prototype version of the PCB 3122. Such electrical loss may not be present in production version of the PCB 3122, wherein PCB traces on the PCB 3122 are used to provide the paths 3126-3131. Therefore, the efficiency loss 3309 versus frequency 3310 for each antenna 3306-3321 may improve in the graph 3300 by about 1.3 dB in a production version of the PCB 3300.

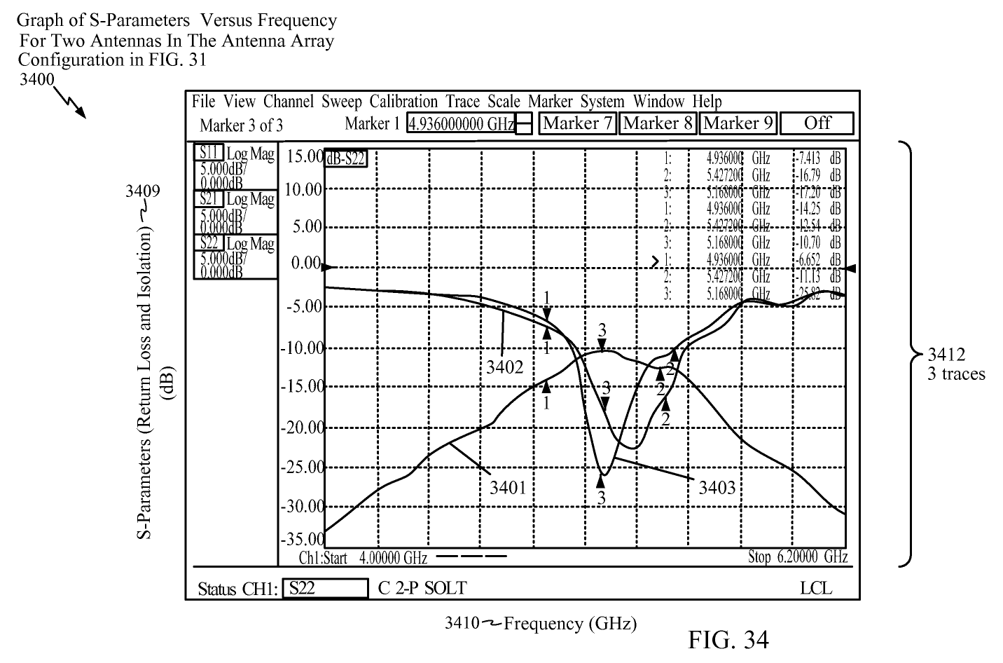

FIG. 34 illustrates an example of a graph 3400 of S-parameters 3409 versus frequency 3410 for two adjacent antennas in the antenna array configuration 3104, as shown in FIG. 31, in accordance with certain aspects of the present disclosure.

The graph 3400 represents S-parameters 3409 (e.g., return loss and isolation) from 0 to −35 dB. The graph 3400 represents frequency range from 4000 to 6200 MHz. A process for measuring S-parameters 3409 versus frequency 3410 for an antenna array is well known to those skilled in the art of antenna array designs. FIG. 3400 illustrates acceptable performance for S-parameters 3409 versus frequency 3410 for the antenna array configuration 3104.

The graph 3400 illustrates three traces 3412, wherein each trace 3401-3403 corresponds to S-parameters 3409 versus frequency 3410 for two adjacent antennas. In particular, traces 3402 and 3403 correspond to return loss 3409 versus frequency 3410 between two adjacent antennas 3106 and 3107, respectively. Trace 3401 represents isolation 3409 versus frequency 3410 between the two adjacent antennas 3106 and 3107.

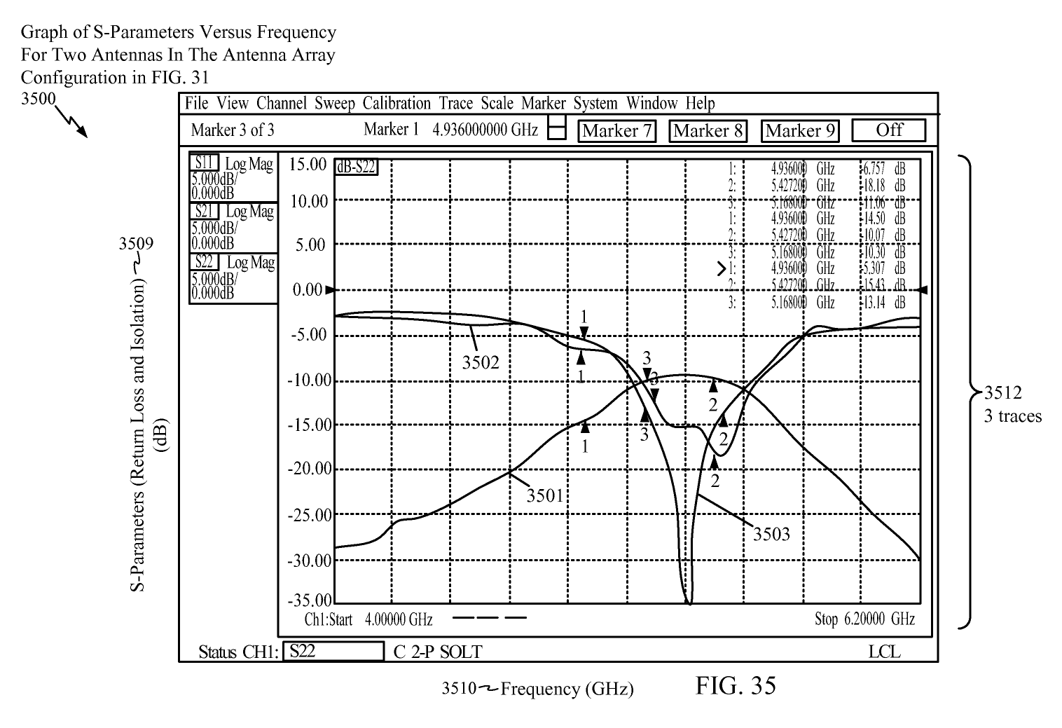

FIG. 35 illustrates an example of a graph 3500 of S parameters 3509 versus frequency 3510 for the antenna array configuration 3104, as shown in FIG. 31, in accordance with certain aspects of the present disclosure.

The graph 3500 represents S-parameters 3509 from 0 to −35 dB. The graph 3500 represents frequency range from 4000 to 6200 MHz. A process for measuring S-parameters 3509 versus frequency 3510 for an antenna array is well known to those skilled in the art of antenna array designs. FIG. 3500 illustrates acceptable performance for S-parameters 3509 versus frequency 3510 for the antenna array configuration 3504.

The graph 3500 illustrates three traces 3512, wherein each trace 3501-3503 corresponds to S-parameters 2809 versus frequency 2810 for two adjacent antennas. In particular, traces 3502 and 3503 correspond to return loss 3509 versus frequency 3510 between two adjacent antennas 3113 and 3114, respectively. Trace 3501 represents isolation 3509 versus frequency 3510 between the two adjacent antennas 3113 and 3114.

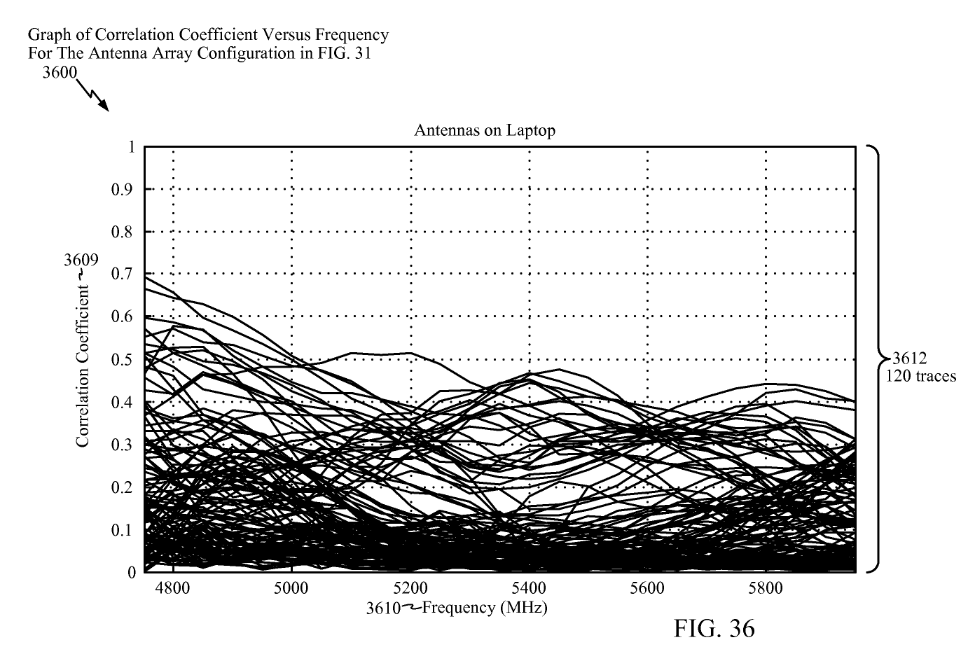

FIG. 36 illustrates an example of a graph 3600 of correlation coefficient 3609 versus frequency 3610 for the antenna array configuration 3104, as shown in FIG. 31, in accordance with certain aspects of the present disclosure.

The graph 3600 represents correlation coefficients 3609 from 0 to 1. The graph 3600 represents frequency range from 4700 to 6000 MHz. A process for measuring correlation coefficients 3609 versus frequency 3610 for an antenna array is well known to those skilled in the art of antenna array designs. FIG. 36 illustrates acceptable performance for correlation coefficients 3609 versus frequency 3610 for the antenna array configuration 3104.

The graph 3600 illustrates 120 traces 3612, wherein each trace corresponds to correlation coefficients 3609 versus frequency 3610 among the antennas 3106-3121. For example, one trace represents correlation coefficients 3609 versus frequency 3610 between antennas 3606 and 3607, another represents correlation coefficients 3609 versus frequency 3610 between antennas 3606 and 3608, and so forth.

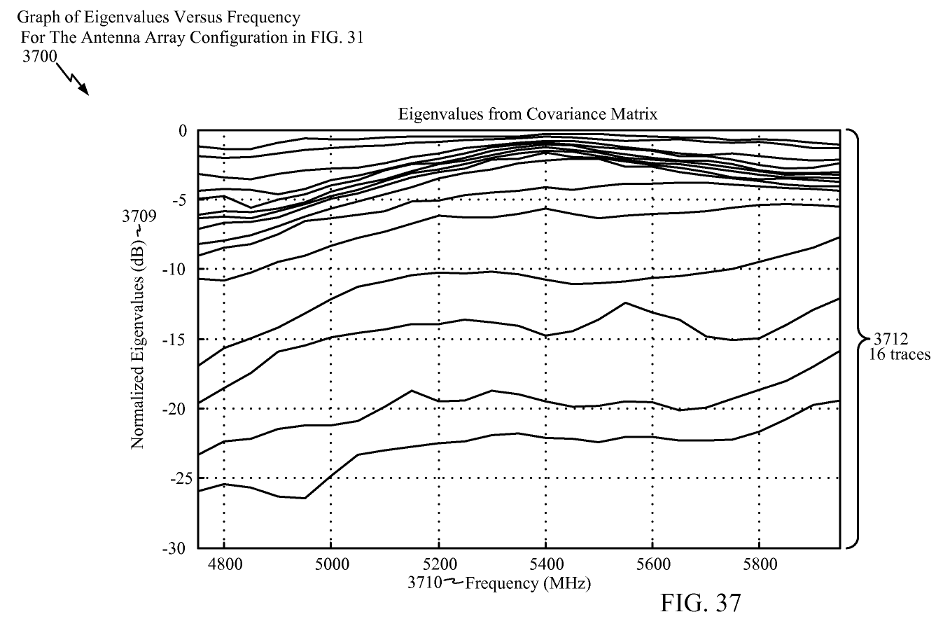

FIG. 37 illustrates an example of a graph 3700 of Eigenvalues 3709 of the covariance matrix versus frequency 3710 for the antenna array configuration 3104, as shown in FIG. 31, in accordance with certain aspects of the present disclosure.

The graph 3700 represents Eigenvalues 3709 from 0 to −30 dB. The graph 3700 represents frequency range from 4700 to 6000 MHz. A process for calculating Eigenvalues 3709 versus frequency 3710 from radiation patterns for an antenna array is well known to those skilled in the art of antenna array designs. FIG. 37 illustrates acceptable performance for Eigenvalues 3709 versus frequency 3710 for the antenna array configuration 3104.

The graph 3700 illustrates sixteen traces 3712, wherein each trace corresponds to Eigenvalues 3709 versus frequency 3710 sorted according to their magnitude. The first trace is normalized to 0 dB.

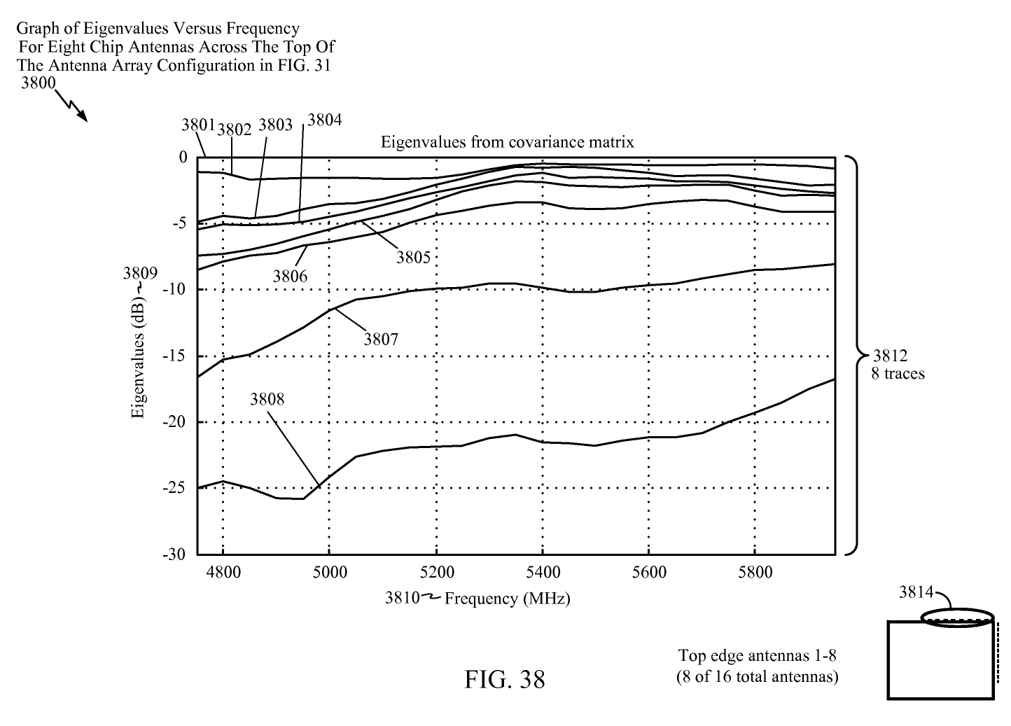

FIG. 38 illustrates an example of a graph 3800 of Eigenvalues 3809 versus frequency 3810 for eight chip antennas 3106-3113 (also numbered antennas 1-8) across the top of the antenna array configuration 3104, as shown in FIG. 31, and as shown schematically as 3814 in FIG. 38, in accordance with certain aspects of the present disclosure.

The graph 3800 represents Eigenvalues 3809 from 0 to −30 dB. The graph 3800 represents frequency range from 4700 to 6000 MHz. A process for calculating Eigenvalues 3809 versus frequency 3810 from radiation patterns for an antenna array is well known to those skilled in the art of antenna array designs. FIG. 38 illustrates acceptable performance for Eigenvalues 3809 versus frequency 3810 for the antenna array configuration 3104.

The graph 3800 illustrates eight traces 3812, wherein each trace corresponds to Eigenvalues 3809 versus frequency 3810 among the antennas 3106-3113. The first trace 3801 is normalized to 0 dB.

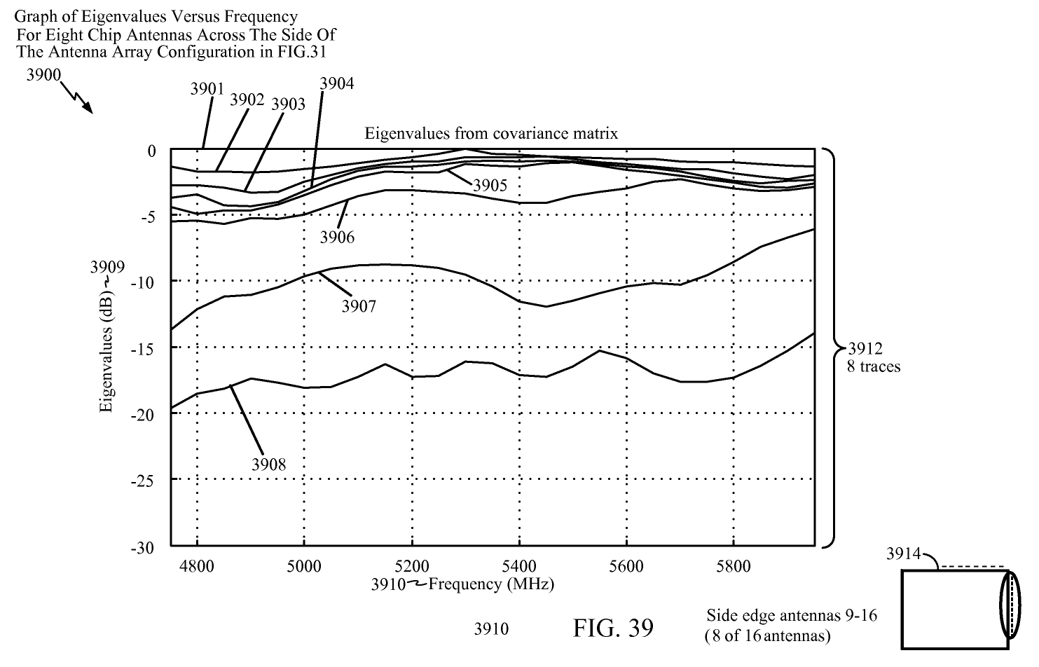

FIG. 39 illustrates an example of a graph 3900 of Eigenvalues 3909 versus frequency 3910 for eight chip antennas 3114-3121 (also numbered antennas 9-16) across the right side of the antenna array configuration 3104, as shown in FIG. 31, and as shown schematically as 3914 in FIG. 38, in accordance with certain aspects of the present disclosure.

The graph 3900 represents Eigenvalues 3909 from 0 to −30 dB. The graph 3900 represents frequency range from 4700 to 6000 MHz. A process for calculating Eigenvalues 3909 versus frequency 3910 from radiation patterns for an antenna array is well known to those skilled in the art of antenna array designs. FIG. 39 illustrates acceptable performance for Eigenvalues 3909 versus frequency 3910 for the antenna array configuration 3104.

The graph 3900 illustrates eight traces 3912, wherein each trace corresponds to Eigenvalues 3909 versus frequency 3910 among the eight chip antennas 3114-3121. The first trace 3901 is normalized to 0 dB.

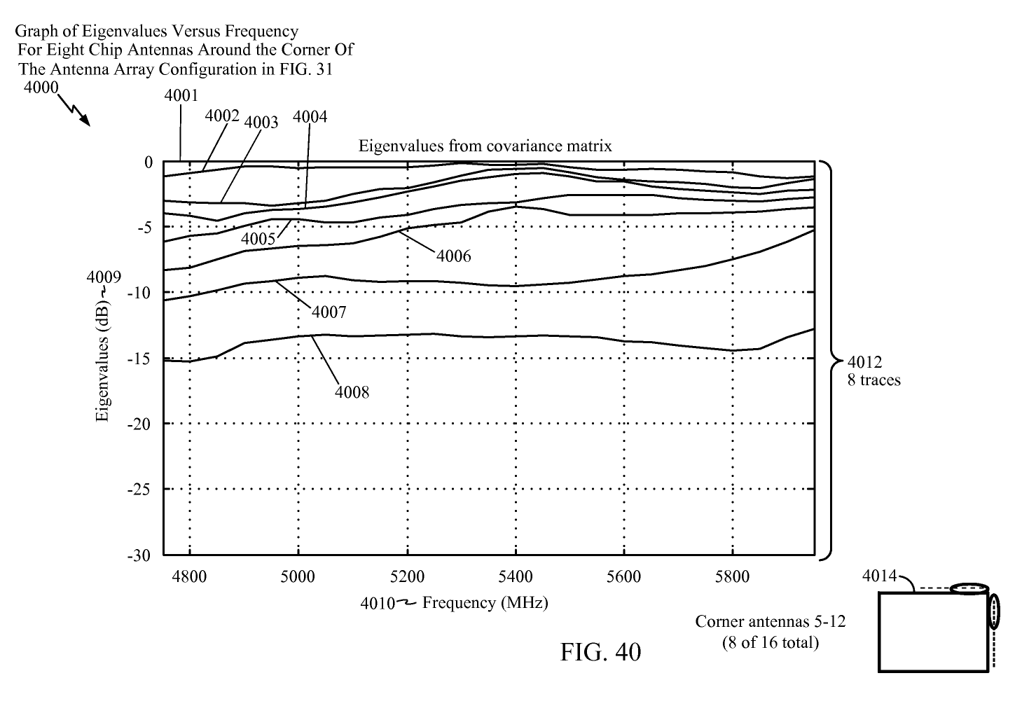

FIG. 40 illustrates an example of a graph 4000 of Eigenvalues 4009 versus frequency 4010 for eight chip antennas 3110-3127 (also numbered antennas 5-12) around the right top corner of the antenna array configuration 3104, as shown in FIG. 31, and as shown schematically as 4014 in FIG. 40, in accordance with certain aspects of the present disclosure.

The graph 4000 represents Eigenvalues 4009 from 0 to −30 dB. The graph 4000 represents frequency range from 4700 to 6000 MHz. A process for calculating Eigenvalues 4009 versus frequency 4010 from radiation patterns for an antenna array is well known to those skilled in the art of antenna array designs. FIG. 40 illustrates acceptable performance for Eigenvalues 4009 versus frequency 4010 for the antenna array configuration 3104.

The graph 4000 illustrates eight traces 4012, wherein each trace corresponds to Eigenvalues 4009 versus frequency 4010 among the eight chip antennas 3110-3127. The first trace 4001 is normalized to 0 dB.

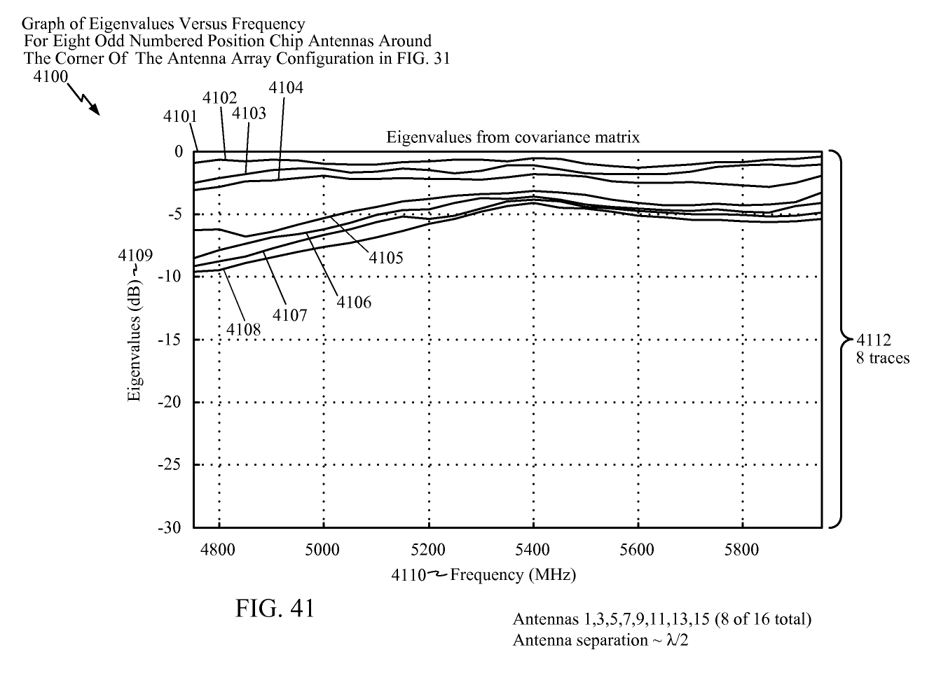

FIG. 41 illustrates an example of a graph 4100 of Eigenvalues 4109 versus frequency 4110 for eight odd numbered position chip antennas 3106, 3108, 3110, 3112, 3114, 3116, 3118, and 3120 (also numbered antennas 1, 3, 5, 7, 9, 11, 13, and 15) across the top and right side of the antenna array configuration 3104, as shown in FIG. 31, and as shown schematically as 3914 in FIG. 38, in accordance with certain aspects of the present disclosure. The separation between two measured antennas (i.e., two antennas separated by only one other antenna) is one half wavelength.

The graph 4100 represents Eigenvalues 4109 from 0 to −30 dB. The graph 4100 represents frequency range from 4700 to 6000 MHz. A process for calculating Eigenvalues 4109 versus frequency 4110 from radiation patterns for an antenna array is well known to those skilled in the art of antenna array designs. FIG. 41 illustrates acceptable performance for Eigenvalues 4109 versus frequency 4110 for the antenna array configuration 3104.

The graph 4100 illustrates eight traces 4112, wherein each trace corresponds to Eigenvalues 4109 versus frequency 4110 among the eight chip antennas 3106, 3108, 3110, 3112, 3114, 3116, 3118, and 3120. The first trace 3106 is normalized to 0 dB.

6. Laptop Having a PCB with Eight Monopole Antennas.

FIG. 42 illustrates an example of a laptop 4200 employing a printed circuit board (PCB) 4202 employing eight (8) printed monopole antennas 4206-4213 for use with the system 100, as shown in FIGS. 1 and 2, in accordance with certain aspects of the present disclosure. FIG. 43 illustrates a magnified view 4300 of top right corner of the example shown in FIG. 42, in accordance with certain aspects of the present disclosure. The laptop 4200 may be of the type having two housings hinged together, as shown in FIGS. 31 and 32. The eight (8) printed monopole antennas 4206-4213 are advantageously carried by the first housing to provide for quality communications when the first housing (e.g., also carrying a 13 inch display) is in an open position (e.g., greater than 90 degrees) relative to the second housing.

The laptop 4200 generally includes a printed circuit board 4202, a ground plane 4204, and eight (8) printed monopole antennas 4206-4213 (also labeled 1-8, respectively) forming an antenna array 4204. Also illustrated in FIG. 42 are eight (8) electrically conductive paths 4215-4222, and eight (8) connectors 4223-4230.

The PCB 4202 may have a width dimension 4232 of 255 mm and a length dimension 4234 of 210 mm. The PCB 4202 may extend beyond the ground plane 3124 at the top right corner of the PCB 4202 permitting a non-grounded border portion of the PCB to have a right border dimension 4264 of 5 mm and a top border dimension 4266 of 5 mm. In FIGS. 42 and 43, each printed monopole antenna 4202-4213 has characteristics, as described above with reference to FIGS. 3, 4, 8-10, and 16-18. Other dimensions or features, such as these described as well as other features, shown in FIGS. 41 and 42, may be permitted within the scope of the present invention.

Individually, various design and engineering details for prototype and production versions of each of the printed circuit board 4202 (e.g. FR4), the ground plane 4204, the eight (8) printed monopole antennas 4206-4213, the eight (8) electrically conductive paths 4215-4222, and the eight (8) connectors 4223-4230, are well known to those skilled in the art of those individual elements.

The laptop 4200 has four (4) printed monopole antennas 4206-4209 located along a top side and near a top right corner of the PCB 4202, and four (4) printed monopole antennas 4210-4213 located along a right side and near a top right corner of the PCB 4202. Other configurations of the antenna array 4204 are possible and may be used within the scope of the present invention.

The antenna array 4204, illustrated in FIGS. 41 and 42, advantageously permits the laptop 4200, having dimensions compatible with industry standard or manufactured dimensions (e.g., length and width), to be adapted for use in a 8×8 MIMO communication system 100. The antenna array 4204, 8×8 for example, is small enough to fit at top right corner of the PCB 4202 while provide an acceptable antenna radiation pattern, and other acceptable communications characteristics, which are not shown in graphs, but are similar to the characteristics of other printed monopole antenna designs described herein.

Fitting of high order antenna arrays into mobile and portable handheld devices, such as cellular phones and smart phones may be a challenging task because of their size. However, the techniques presented herein may allow for compact arrays that may be incorporated into such devices to increase data throughput for applications running on such devices.

Very high data rate wireless communication systems may be utilized for the transmission of high definition (HD) video signals. By exploiting the size of HD devices, such as widescreen HD television sets, one or more high order antenna arrays (e.g., with eight or sixteen elements) may be incorporated into such devices and spaced out accordingly in order to improve the spatial diversity and decrease the correlation between antenna pairs.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The description and drawings are illustrative of aspects and examples of the invention and are not to be construed as limiting the invention. The word “exemplary” is used herein to mean “serving as an example, instance, or illustration.” Any embodiment described herein as “exemplary” is not necessarily to be construed as preferred or advantageous over other aspects.

Numerous specific details are described to provide a thorough understanding of the present invention. However, in certain instances, well-known or conventional details are not described in order to avoid obscuring the description of the present invention. References to one embodiment or an embodiment in the present disclosure are not necessarily to the same embodiment, and such references may include one or more embodiments.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. An antenna array for use in multiple input multiple output (MIMO) communications, comprising:
a ground plane formed by an electrically conductive surface having a ground potential; and
a plurality of antenna elements, located near the ground plane, for transmitting and receiving a wireless communication signals over a predetermined wireless channel.

2. The antenna array of claim 1, wherein the plurality of antenna elements are tuned for a carrier frequency having a corresponding wavelength, λ, and wherein adjacent antenna elements of the plurality of antenna elements are positioned to be separated by a distance less than λ/2.

3. The antenna array of claim 2, wherein the distance corresponds to λ/4.

4. The antenna array of claim 1, wherein at least one antenna element of the plurality of antenna elements are located at a perimeter of the ground plane.

5. The antenna array of claim 4, wherein the at least one antenna element of the plurality of antenna elements further comprises:
a printed circuit antenna element.

6. The antenna array of claim 5, wherein the printed circuit antenna element further comprises:
a monopole antenna element.

7. The antenna array of claim 1, wherein at least one antenna element of the plurality of antenna elements are located above and adjacent to the ground plane.

8. The antenna array of claim 7, wherein the at least one antenna element of the plurality of antenna elements further comprises:
a planar inverted F-type antenna (PIFA).

9. The antenna array of claim 7, wherein the at least one antenna element of the plurality of antenna elements further comprises:
a donut antenna.

10. The antenna array of claim 1, wherein the at least one antenna element of the plurality of antenna elements further comprises:
a ceramic chip antenna element.

11. The antenna array of claim 10, wherein the ceramic chip antenna element further comprises:
a wire inverted F antenna (WIFA).

12. The antenna array of claim 1, further comprising:
a substrate being electrically non-conductive and supporting at least one antenna element of the plurality of antenna elements and supporting the ground plane.

13. The antenna array of claim 1, further comprising:
a conductive path electrically coupled to each antenna element.

14. The antenna array of claim 13, further comprising:
a connector electrically coupled to each conductive path.

15. The antenna array for claim 1, wherein the plurality of antenna elements further comprises:
a first antenna element having a first field radiation pattern; and
a second antenna element having a second field radiation pattern, different from the first field radiation pattern.

16. The antenna array for claim 1, wherein the plurality of antenna elements further comprises:
a first antenna element being oriented in a first radiation direction; and
a second antenna element being oriented in a second radiation direction, different from the first radiation direction.

17. A wireless communications device, comprising:
an antenna array comprising:
a ground plane formed by an electrically conductive surface having a ground potential; and
a plurality of antenna elements, located near the ground plane, for transmitting and receiving a wireless communication signals over a predetermined wireless channel;
a first radio frequency (RF) transceiver, electrically coupled to a first antenna element of the plurality of antenna elements, for transmitting and receiving a first wireless communication signal over a predetermined wireless channel; and
a second radio frequency (RF) transceiver, electrically coupled to the second antenna element of the plurality of antenna elements, for transmitting and receiving a second wireless communication signal over the predetermined wireless channel.

18. The wireless communications device of claim 17, wherein the plurality of antenna elements of the antenna array are tuned for a carrier frequency having a corresponding wavelength, λ, and wherein adjacent antenna elements of the plurality of antenna elements are positioned to be separated by a distance less than λ/2.

19. The wireless communications device of claim 18, wherein the distance corresponds to λ/4.

20. The wireless communications device of claim 17, further comprising:
a conductive path electrically coupled to each of the plurality of antenna elements; and
a connector electrically coupled to each conductive path.

21. The wireless communications device of claim 17,
wherein at least one antenna element of the plurality of antenna elements are located at a perimeter of the ground plane, and
wherein at least another antenna element of the plurality of antenna elements are located above a surface of the ground plane.

22. The wireless communications device of claim 17, wherein the device comprises a portable device.

23. The wireless communications device of claim 22, wherein the antenna array is integrated into a chassis of the portable device.

24. The wireless communications device of claim 22, wherein the portable device comprises one of a phone, a laptop, a personal computer, a camera, and a camcorder.

25. The wireless communications device of claim 17, wherein the device comprises a high definition (HD) television.

26. The wireless communications device of claim 17, wherein the device comprises a personal computer memory card.

27. An antenna array for use in multiple input multiple output (MIMO) communications, comprising:
a ground plane formed by an electrically conductive surface having a ground potential; and
a plurality of antenna elements, located near the ground plane, for transmitting and receiving a wireless communication signals over a predetermined wireless channel,
wherein at least one antenna element of the plurality of antenna elements are located at a perimeter of the ground plane, and
wherein at least one antenna element of the plurality of antenna elements are located above and adjacent to the ground plane.

28. The antenna array of claim 27, wherein the plurality of antenna elements are tuned for a carrier frequency having a corresponding wavelength, λ, and wherein adjacent antenna elements of the plurality of antenna elements are positioned to be separated by a distance less than λ/2.

29. The antenna array of claim 28, wherein the distance corresponds to λ/4.

30. The antenna array of claim 27, wherein the plurality of antenna elements further comprises:
a first antenna element having a first field radiation pattern; and
a second antenna element having a second field radiation pattern, different from the first field radiation pattern.

31. The antenna array of claim 27, wherein the plurality of antenna elements further comprises:
a first antenna element being oriented in a first radiation direction; and
a second antenna element being oriented in a second radiation direction, different from the first radiation direction.

32. An antenna array for use in multiple input multiple output (MIMO) communications, comprising:
a ground plane formed by an electrically conductive surface having a ground potential; and
a plurality of antenna elements, located near the ground plane, for transmitting and receiving a wireless communication signals over a predetermined wireless channel,
wherein at least one antenna element of the plurality of antenna elements are located at a perimeter of the ground plane,
wherein at least one antenna element of the plurality of antenna elements are located above and adjacent to the ground plane,
wherein the plurality of antenna elements are tuned for a carrier frequency having a corresponding wavelength, λ, and wherein adjacent antenna elements of the plurality of antenna elements are positioned to be separated by a distance less than λ/2, and
wherein the plurality of antenna elements further comprises:
a first antenna element having a first field radiation pattern;
a second antenna element having a second field radiation pattern, different from the first field radiation pattern;
a third antenna element being oriented in a first radiation direction; and
a fourth antenna element being oriented in a second radiation direction, different from the first radiation direction.

33. The antenna array of claim 32, wherein the distance corresponds to λ/4.

34. A personal computer memory card international association (PCMCIA) card comprising:
a printed circuit board (PCB) having printed thereon a ground plane formed by an electrically conductive surface having a ground potential, wherein a proximate end of the PCB is adapted to be electrically coupled to a device, and wherein a distal end of the PCB provides an antenna array, for use in multiple input multiple output (MIMO) communications, including a plurality of antenna elements, for transmitting and receiving a wireless communication signals over a predetermined wireless channel,
wherein a first plurality of antenna elements of the plurality of antenna elements are disposed on the distal end of the PCB, are located at a perimeter of the ground plane, and have a first field radiation pattern, and
wherein the plurality of antenna elements are tuned for a carrier frequency having a corresponding wavelength, λ, and wherein adjacent antenna elements of the plurality of antenna elements are positioned to be separated by a distance less than λ/2.

35. The antenna array of claim 34, wherein the distance corresponds to λ/4.

36. The antenna array of claim 34, wherein each of the first plurality of antenna elements further comprises:
a printed circuit antenna element forming a monopole antenna element.

37. The antenna array of claim 34, wherein each of the first plurality of antenna elements further comprises:
a ceramic chip antenna element forming a wire inverted F antenna (WIFA).

38. The antenna array of claim 34, wherein a second plurality of antenna elements of the plurality of antenna elements are disposed on the distal end of the PCB, are located above and adjacent to the ground plane, and have a second field radiation pattern.

39. The antenna array of claim 38, wherein the second plurality of antenna elements further comprises at least one of the following:
a planar inverted F-type antenna (PIFA); and a donut antenna.

40. A wireless communications device, comprising:
an antenna array comprising:
a printed circuit board (PCB) having printed thereon a ground plane formed by an electrically conductive surface having a ground potential; and
an antenna array, for use in multiple input multiple output (MIMO) communications, including a plurality of antenna elements are disposed on the PCB, are distributed and positioned around a corner of the PCB, are located at a perimeter of the ground plane, and have a field radiation pattern,
wherein the plurality of antenna elements are tuned for a carrier frequency having a corresponding wavelength, λ, and wherein adjacent antenna elements of the plurality of antenna elements are positioned to be separated by a distance less than λ/2,
a first radio frequency (RF) transceiver, electrically coupled to a first antenna element of the plurality of antenna elements, for transmitting and receiving a first wireless communication signal over a predetermined wireless channel; and
a second radio frequency (RF) transceiver, electrically coupled to the second antenna element of the plurality of antenna elements, for transmitting and receiving a second wireless communication signal over the predetermined wireless channel.

41. The wireless communications device of claim 40, wherein the distance corresponds to λ/4.

42. The wireless communications device of claim 40, wherein each of the first plurality of antenna elements further comprises:
a printed circuit antenna element forming a monopole antenna element.

43. The wireless communications device of claim 42, wherein each of the first plurality of antenna elements further comprises:
a ceramic chip antenna element forming a wire inverted F antenna (WIFA).
